(19) United States
(12) Patent Application Publication
(10) Pub. No.: US 2005/0198629 A1
(43) Pub. Date: Sep. 8, 2005

(54) Method and system for provisioning servers based on a policy and rule hierarchy

(76) Inventor: Vipul Vishwanath, Santa Clara, CA (US)

Correspondence Address: Sean M. Fitzgerald, 3182 Campus Drive #342, San Mateo, CA, 94403-3123, US

(21) Appl. No.: 10/956,746

(22) Filed: Sep. 30, 2004

Related U.S. Application Data
(60) Provisional application No. 60/510,721, filed on Oct. 10, 2003.

(51) Int. Cl. G06F 9/445

(52) U.S. Cl. 717/174

(57) ABSTRACT

A provisioning system selects the appropriate action to take in provisioning a server computer by retrieving information on the build operators associated with a policy applied to the server, retrieves state file information on state files associated with the build operator, and selects the appropriate state file associated with the build operator based on the state value, the state value indicating the current stage of the provisioning process. Provisioning rules contained within the state file are selected based upon comparing criteria contained in the rule against the attributes of the server. An instruction set is extracted from the selected rule executed. The instructions within the instruction set may specify using a vendor tool or performing other tasks in provisioning the server.

### BACKGROUND

1. Field of the Invention

The present invention relates, generally, to the provisioning of computers. More particularly, the present invention relates to the installation of software on computers or other networked electronic devices.

2. Related Background

While computers have been around for many years the process of installing software and provisioning computers has not changed significantly for most data center operations. Even today, most computers are provisioned either manually or through an image-based process. In data centers it is still common for servers to be provisioned manually. There are many reasons for this. Image based solutions are inherently limited, in that an image from a similar, though not identical, computer may not work for the intended target. Image based solutions also do not allow the installation of some commercial software products, such as Microsoft's® Exchange™ Server. Manual installation is inherently slow, error prone and labor intensive.

Automated non-imaged based installation methods typically involve the use of scripts or other systems which can install software, even an operating system, without human intervention. Such unattended installation methods typically are designed to handle a particular type of server, often from only one manufacturer, and can not handle the installation of different operating systems or software on different types of computers. Furthermore, most hardware vendors have developed their own best practices for the provisioning of their servers. Existing automated provisioning systems do not easily allow for the incorporation of these best practices, especially as new hardware platforms, operating systems, software and vendor tools are introduced after the existing systems are deployed in a data center.

Accordingly, the present invention seeks to overcome these and other disadvantages and limitations in conventional provisioning systems and methods.

### SUMMARY

The present invention provides a system and method for provisioning a computer. A provisioning system is connected to a group of target computers through a communication network. The provisioning system includes a provisioning engine for controlling the provisioning process, a TFTP server for downloading software to the target, a network address server for providing the target with network address information, a file server for storing software, a state and discovery database for storing data regarding the provisioning of the target, and a rules and policy database for storing provisioning instructions and conditions. Vendor tools stored in the file server are used to provision computers according to the instructions contained in the rules and policies stored in the rules and policy database. In determining which instructions to follow in provisioning a given target the provisioning system compares information from the target against the attributes of a policy to find the rule in the policy with the greatest specificity to the attributes of the target.

The state file includes a state value corresponding to a predetermined set of provisioning states. A state machine running on the target computer retrieves the state value stored in the state and policy database and uses the retrieved state value to determine which instructions the provisioning program is to execute in provisioning the target. Based on the retrieved state value, the provisioning program selects the appropriate state file from the hardware build operator (contained within a policy that has been applied to the target computer). The state file contains a ruleset which is a collection of provisioning rules corresponding to the action that the provisioning program is to take in provisioning the target computer at that stage of the provisioning process. In one aspect of the present invention the action the provisioning program carries out is the retrieval and execution of a vendor tool. The rules are segregated by key attribute information, such that the system will select only one rule based upon the best match between the target computer and the key attribute criteria associated with the rule. Rules include one instruction set. The instruction set includes at least one instruction for the provisioning program to execute. The instruction may specify a vendor tool to execute, and includes information on where to obtain the vendor tool.

### BRIEF DESCRIPTION OF THE FIGURES

FIG. 1 is generalized block diagram of a computer system that may be used to implement the present invention.

FIG. 2 is a generalized block diagram of a server computer that may be used to implement the present invention.

FIG. 3 is a generalized block diagram of the software components of the provisioning server, in accordance with the present invention.

FIG. 4 is a flow diagram illustrating the process of the provisioning server in provisioning a target server, in accordance with the present invention.

FIG. 5 is a communication flow diagram corresponding to FIGS. 4 and 6, in accordance with the present invention.

FIG. 6 is a flow diagram illustrating the pre-boot stage of the target server in provisioning the target server corresponding to FIGS. 4 and 5, in accordance with the present invention.

FIG. 7 is a flow diagram illustrating the progression of states in preparing the target server for provisioning, in accordance with the present invention.

FIG. 8 is a flow diagram illustrating the process of creating a RAMDISK and copying system tools of the first target preparation state, in accordance with the present invention.

FIG. 9 is a flow diagram illustrating the process of selecting and installing a device driver and communication software in the second target preparation state, in accordance with the present invention.

FIG. 10 is a flow diagram illustrating the process of authenticating the target and connecting to the provisioning server in a third target preparation state, in accordance with the present invention.

FIG. 11 is a generalized block diagram of the software components of the provisioning program, in accordance with the present invention.

FIG. 12 is a flow diagram illustrating the process of provisioning the target computer in post boot stage, in accordance with the present invention.

FIG. 13 is a flow diagram illustrating the process of selecting an appropriate rule from a state file, in accordance with the present invention.

FIG. 14 is a flow diagram illustrating the process of resolving and implementing instructions from a rule, in accordance with the present invention.

FIG. 15 is a graphical representation showing the hierarchical relationship between policies, constraints, build operators, rule sets, rules, instruction sets and instructions, in accordance with the present invention.

FIG. 16 is a flow diagram illustrating the process of resolving actions from policies applied to a target server, in accordance with the present invention.

FIG. 17 is a flow diagram illustrating the progression of states of the system, in accordance with the present invention.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto.

### DETAILED DESCRIPTION

The present invention is described in the context of a specific embodiment. This is done to facilitate the understanding of the features and principles of the present invention and the present invention is not limited to this embodiment. In particular, the present invention is described in the context of provisioning operating systems on servers and devices in the data center environment.

In the following figures like objects are provided with the same identifying number as an aid in understanding the present invention.

### System Architecture

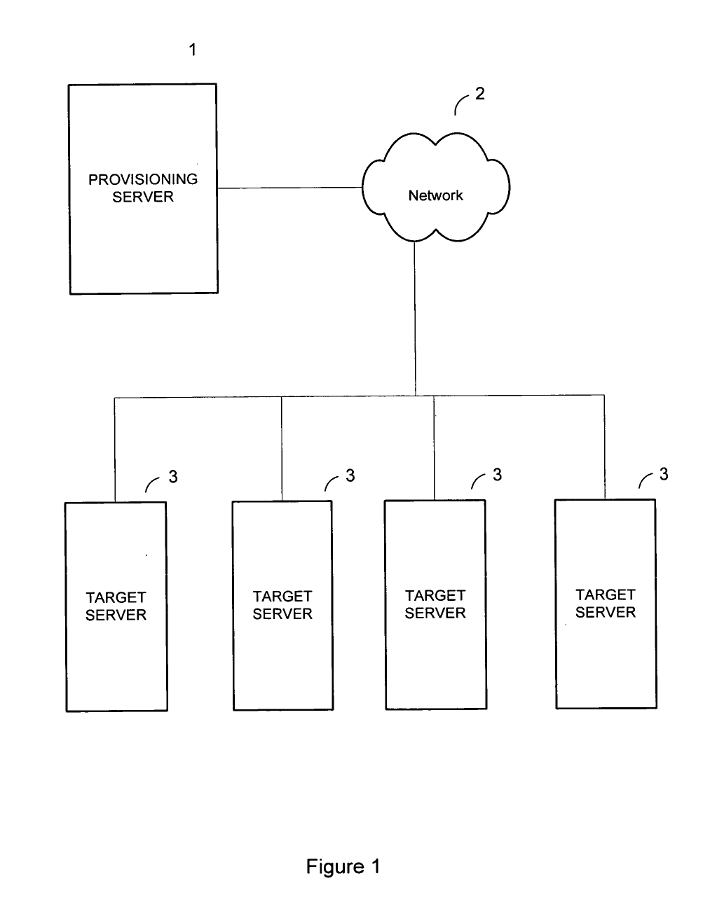

FIG. 1 shows a typical environment where the present invention would be used. A provisioning server 1 is connected via a network 2 to at least one target computer 3. While the example and description below will discuss the provisioning of a sever computer, the present invention is equally applicable to the installation of software on any electronically programmable device, including PCs, network devices such as switches and routers, personal digital assistants, consoles, set-top boxes, cell phones, etc.

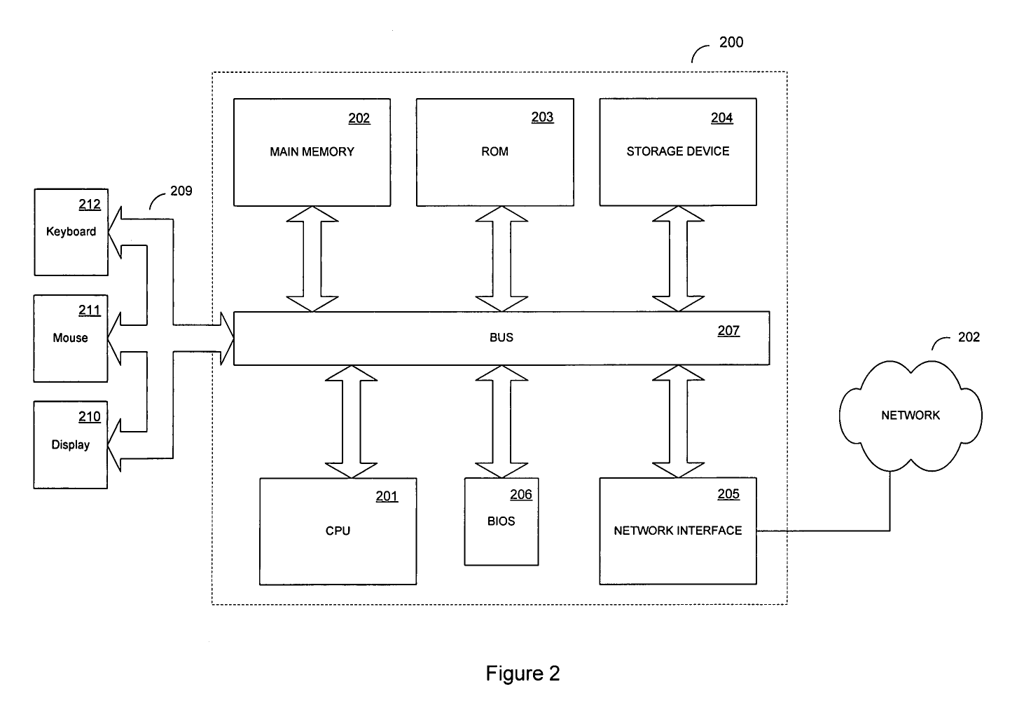

The typical provisioning server is similar in general architecture to the target server. FIG. 2 is a generalized block diagram of a server computer 200 including a central processing unit (CPU) 201, main memory (typically RAM) 202, read-only memory (ROM) 203, a storage device (typically a hard drive) 204, a network device (typically a network interface card, a.k.a. NIC) 205, and a basic input/output system (BIOS) 206. The server includes a bus 207 or other communication mechanism for communicating information between the CPU 201 coupled with bus 207 for processing information. The main memory 202, ROM 203 and storage device 204 are coupled to bus 207 for storing information and instructions to be executed by processor 207. Main memory 202 also may be used for storing temporary variables or other intermediate information during execution of instructions to be executed by processor 201. The BIOS 206 is coupled to the bus 207 for processing input and output information without the need for programs or instructions from main memory 202 or the storage device 204. Typically, the BIOS is implemented as a ROM chip, but may be implemented as flash memory or other type of memory.

Server 201 may be coupled via bus 209 to a display 210, such as a cathode ray tube (CRT) or flat panel monitor, for displaying information to a computer user. An input device 211, such as a keyboard, is coupled to bus 209 for entering information and instructions to the server 200. Additionally, a user input device 212 such as a mouse, a trackball, or cursor direction keys for communicating direction information and command selections to the processor 201 and for controlling cursor movement on the display 210 may be used with the server 200.

The server 200 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the hardware design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

Alternate embodiments of the server computer 200 could use multiple CPUs, or could have additional or primary storage attached to the server in a separate chassis or computer.

As used within the present application, the term “computer-readable medium” refers to any medium that participates in providing instructions to CPU 201 for execution. Such a medium may take many forms, including but not limited to, non-volatile media, volatile media, and transmission media. Examples of non-volatile media include, for example, optical or magnetic disks, such as storage device 204. Examples of volatile media include dynamic memory, such as main memory 202. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 207 and 209. Transmission media can also take the form of acoustic or light waves, such as those generated during radio-wave and infra-red data communications.

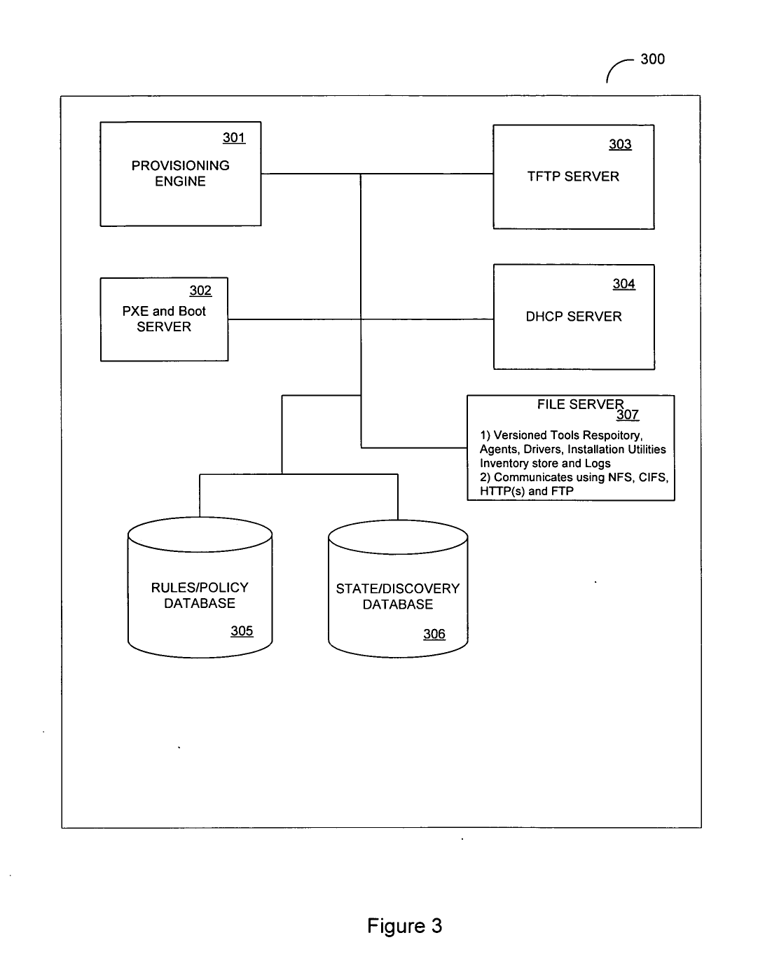

FIG. 3 is a schematic diagram illustrating the system architecture of the present invention. The provisioning server 300 includes the provisioning engine 301, a network boot server 302 (for example, a PXE server, bootp server or Remote Program Load server or a SPARC boot module), TFTP (Trivial File Transfer Protocol) server 303, DHCP (Dynamic Host Configuration Protocol) server 304, rules and policy database 305, state and discovery database 306, and a file server containing software 307. The file server 307 typically has both the software intended for installation, and any software used in the installation process, such as installation tools, hardware configuration tools, and the like. The file system contents may be served by means of an NFS (Network File System) protocol, CIFS (Common Internet File System) protocol, HTTP (HyperText Transport Protocol), HTTPS (Secured HTTP) and FTP (File Transfer Protocol), or any other suitable wireless and/or network communication protocol. While the presently preferred embodiment uses one computer for the provisioning server, alternate embodiments could use multiple computers, and the different functions of the provisioning server could be divided among them according the needs of the particular embodiment.

### Provisioning Process

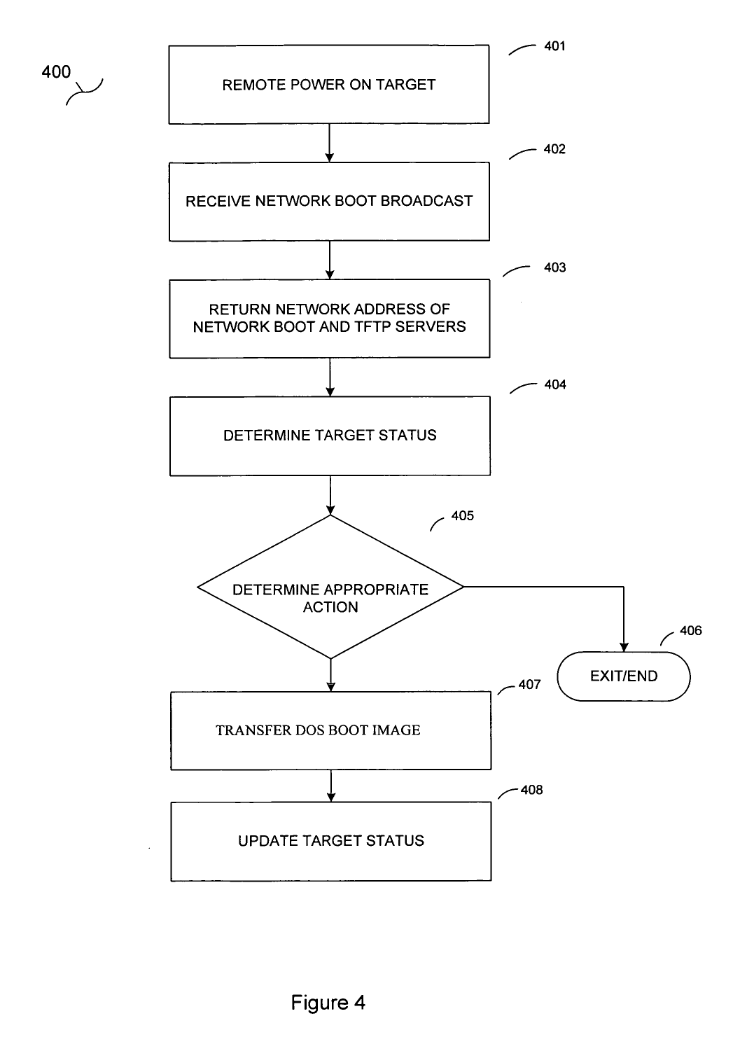

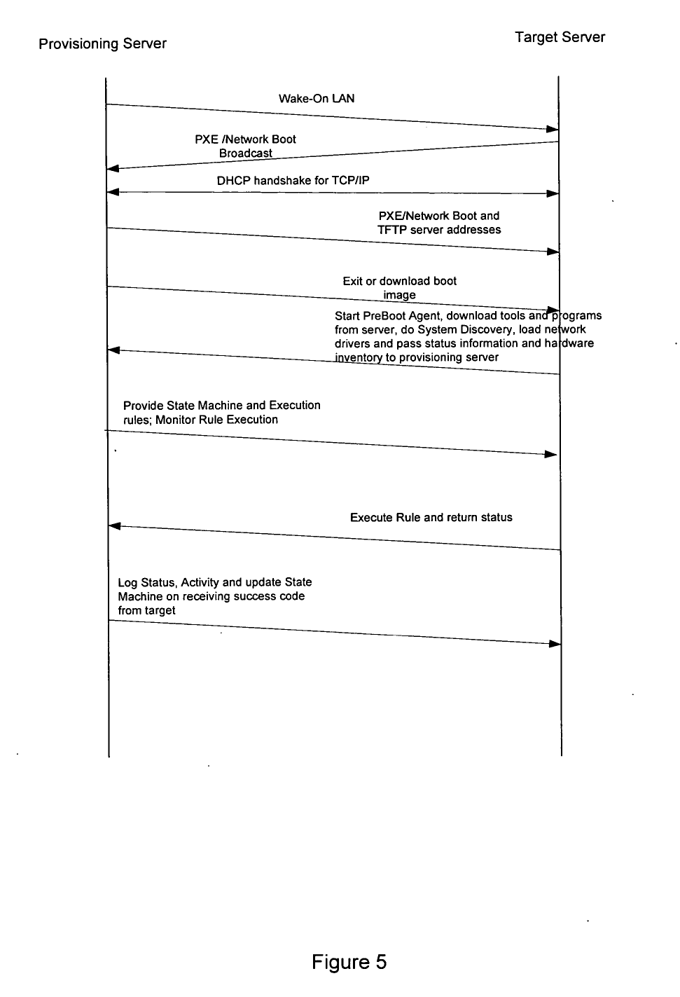

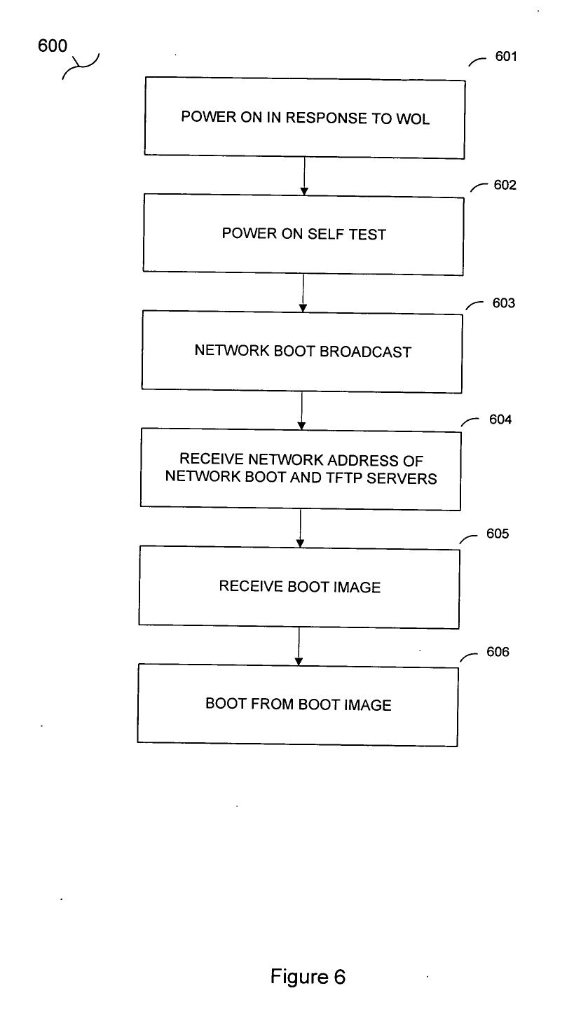

FIG. 4 is a flow diagram showing the initial discovery and provisioning processes 400 performed by the provisioning server of the present invention. Similarly, FIG. 5 shows the communications flow between the provisioning server and the target server during typical operation of the present invention, and corresponds to the flow diagrams of FIGS. 4 and 6.

At step 401 the target is remotely powered on using a Wake On LAN (WOL), powering on the software controlled power strip, whereby a signal is sent over the network which causes the target to power itself on. The target would then typically go though a Power On Self Test (POST). After the POST the target makes a request for a network boot by making a DHCP Discover broadcast over the network, for example PXE™ clients make this broadcast over the network from the network card, if configured for PXE Boot. This broadcast (called the PXE broadcast, since it emanates from a PXE supported device) can be used to execute and start the installation of an operating system over the network. Intel's® Pre-boot Execution Environment (PXE) system, is typically installed as part of ROM memory. The present invention will be described in the specific context of a PXE broadcast, although the present invention is equally applicable to other types of network boot requests broadcasted using DHCP discovery mechanism by Sun SPARC, HP PA-RISC and IBM based system and any network device that can use DHCP discovery broadcast upon initial boot. The PXE network boot stored in ROM includes a basic TCP/IP stack capable of working with most network devices. The limitations of such a basic TCP/IP stack is that the connection it provides is typically less reliable and slower than connections established using the appropriate driver for the particular network device. The PXE network boot also configures a small RAMDISK, to facilitate the downloading of software over the network. A RAMDISK is a temporary allocation in memory to be used as disk space, essentially a virtual hard drive in memory.

The PXE broadcast sent out by the target is a DHCP discover broadcast, requesting network address information for the target as well as network address for the network boot server. The PXE broadcast is received by the provisioning server at step 402. The provisioning server responds to this broadcast at step 403 by sending back an IP address with the appropriate DHCP extension tags. In this manner the target knows the network address of both the PXE server and TFTP server, as well as the target's IP address. The DHCP discover request includes the MAC address of the target. Some types of servers, for example Sun servers, also include a class ID string in the DHCP discover request, which the present invention uses to additionally identify and discover the vendor and model of the target server at step 403.

At step 404 the provisioning server determines the status of the target. Within the state and discovery database is a table matching hardware identifiers, or key attributes of the target computer, to indications of the managed state of the target corresponding to the hardware identifier. In the presently preferred embodiment the attribute of the target used as a target identifier is the MAC address of the target. The MAC address transmitted to the provisioning server and received during the network beet request is checked against the corresponding entry in the state and discovery database. In the presently preferred embodiment, the state and discovery database records three possible managed states for the provisioning of a server: managed, unmanaged and unspecified. As shown in Table 1, managed, unmanaged and unspecified correspond to whether the provisioning server will take over and install an operating system, and whether the server will be instructed to boot under control of the provisioning server or whether the server will boot from the BIOS boot order.

TABLE 1

| State | Description | Control | Instruction |
|---|---|---|---|
| Managed | Target to be managed by | Provisioning Server | Download boot |
| | provisioning server, system | takes control | image |
| | checks to see if target | | |
| | needs to have an OS | | |
| | installed | | |
| Unmanaged | Target not to be managed | Control left to target | Boot target from |
| | or provisioned by | server | target's BIOS |
| | provisioning server | | |
| Unspecified | Target unknown to state | Provisioning server | Download boot |
| | database, provisioning | takes control | image and wait or |
| | server to use default | | relinquish control as |
| | procedure as defined in the | | predefined in the |
| | policy database | | Provisioning Server |
| | | | global settings |

At step 405 the provisioning server determines the appropriate action from the information received at discovery step 404. If at step 405 the provisioning server determines target's corresponding entry in the state and discovery database is marked as unmanaged, the system proceeds to step 406 where the PXE server signals PXE ROM on the target to exit and relinquishes control of the target. The target then boots locally from the BIOS boot order. If at step 405 the system determines the target is marked as managed, and the state store indicates the target has already been built correctly, then the PXE server signals PXE ROM on the target to exit and relinquishes control of target at step 406. The target then falls back to the second item in the BIOS boot order. If at step 405 the target is marked as managed but the state store does not indicate that the target has been built correctly, or if the target is marked as unspecified, the system proceeds to step 407. The present invention provides for a target marked as unspecified to be treated either as managed, proceeding to step 407, or as unmanaged, proceeding to step 406, according to a set of default rules. Default rules entered into the system associate the unspecified status with either of the managed or unmanaged processes in provisioning the target.

At step 407 the provisioning server transfers to the target a boot image, which the target downloads to its memory (typically RAM). Control of the target is passed from the provisioning server to the boot image. The boot image can be created using the MS DOS™, Linux or Solaris or Windows Operating systems—based on which Operating System the hardware vendors distribute their hardware, system, RAID and BIOS configuration tools and network card drivers. In the presently preferred embodiment the boot image includes as basic OS, such as Free-DOS or MSDOS™ a driver library for network cards, TCP/IP software, a network address for the Provisioning Server to help the boot image to connect and download logic, a target profile, as well as a control agent. The control agent is set of executable instructions to identify and inventory the hardware of the target (system ID tools), install the network driver and TCP/IP software, control the boot and installation of Operating System Software, and instruct the target to retrieve a post boot agent and download software using the address included in the boot image. The target profile includes the user name, server name, CIFS share name or NFS mount point and password specific to the target. As discussed in greater detail below, the target then boots from the boot image. After step 407 the system proceeds to step 408 where the status of the target is updated, reflecting the downloading of the boot image to the target.

FIG. 5 illustrates the communication flow between the provisioning server and target during the provisioning process. The target receives a WOL (Wake on LAN) instruction 501 from the provisioning server and responds with a network boot request 502. The provisioning server replies with a DHCP offer 503 and sends the network address information for the network boot image, TFTP server address and any other vendor specific options to the target 504. If the server is to be provisioned according to the process described above, the provisioning server downloads a boot image to the target 505. The target replies with hardware inventory and status information 506. The provisioning server then provides the state value and execution rules for provisioning the target, as well as monitoring the target's execution of provisioning rules 507. The target executes the received rules and returns status information to the provisioning server 508. The provisioning server updates the state machine and returns the updated state value to the target upon receipt of a success code for the prior state 509.

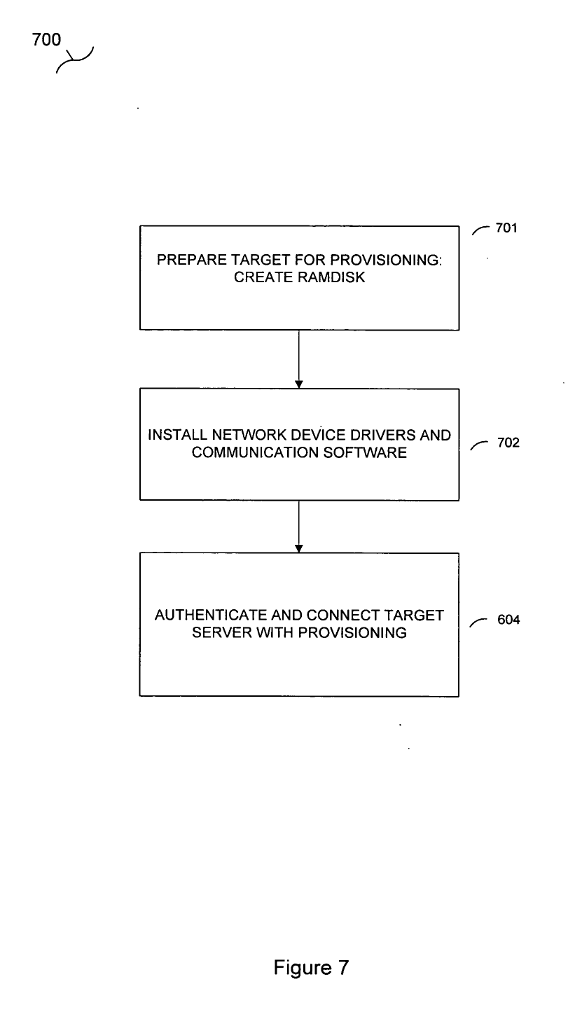

FIGS. 6 through 12 illustrate the provisioning process taking place on the target server described above in connection with FIGS. 4 and 5. FIG. 6 illustrates the pre-boot process, while FIG. 7-12 illustrates the post-boot process. In the pre-boot process there is no OS running on the target server, hence the term “pre-boot.”

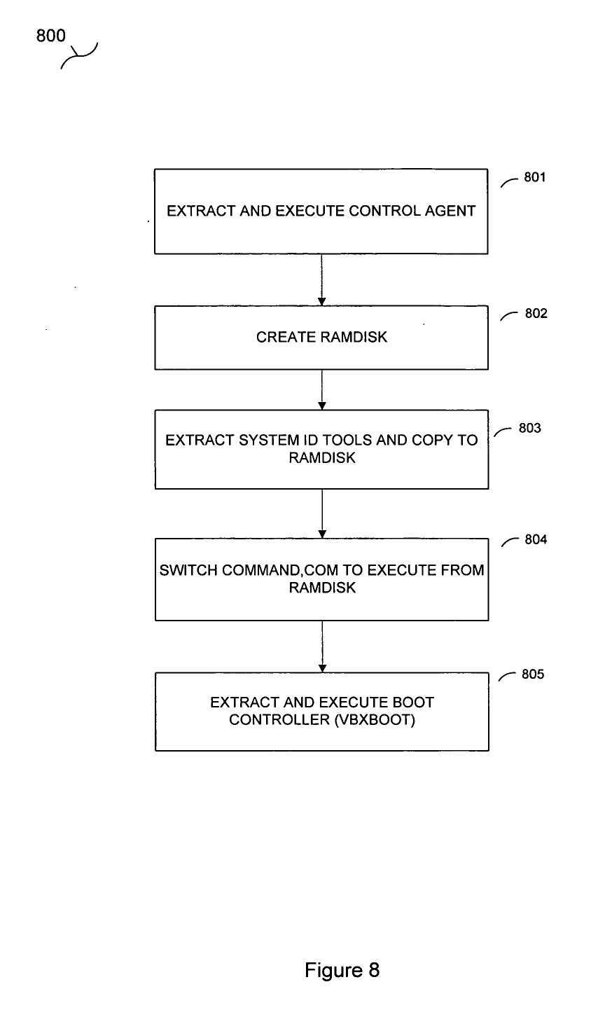

Referring now to FIG. 6, in response to the WOL the target powers itself on at step 601. The target then goes though the POST at step 602, and makes the network boot broadcast, such as a PXE broadcast, over the network at step 603. At step 604 an IP address with the appropriate DHCP extension tags is received for both the PXE server, boot image and TFTP server, as well as the network address information for the target. At step 605 the target receives the boot image from the provisioning server and loads it into main memory. In an embodiment of the present invention utilizing MSDOS as the basic operating system of the boot image, the boot image also includes a TCP/IP stack for MSDOS, MS Network client for DOS, system ID tools, driver library and profile. In the presently preferred embodiment, the library of network device drivers is downloaded with the boot image. Alternate embodiments of the present invention could utilize a remote library of network device drivers. At step 606 the target boots from the boot image loaded into ramdisk. After step 606 the target is then running the OS from the boot image. As stated above, in the presently preferred embodiment the OS included in the boot image is a minimal, or “basic”, OS such as Fee-DOS or MSDOS. These or similar operating systems are chosen as they are much smaller in size than a full-featured OS such as Windows 2000, Solaris or HP-UX™. This is especially important as the ramdisk created by the network boot is often not large enough to download and run a full-featured OS. To illustrate, Intel's PXE creates an initial ramdisk of 5 MB. The RAMDISK created during the process described in connection with FIG. 8 is 8 MB in the presently preferred embodiment. (In the present application, the following convention is used where lower case “ramdisk” is refers to ramdisk created by PXE or other network boot system, while upper case “RAMDISK” refers to ramdisk created by the logic of the present invention). The boot image of the presently preferred embodiment for a server with x86 architecture CPUs includes MSDOS is approximately 1.5 MB, with the “basic” OS MSDOS having a file size of approximately 290 KB. This contrasts with a full featured OS such as Windows 2003 which is approximately 700 MB, which is too large to run in a ramdisk capable of being created on typical servers. The file size of Windows 2003 is similar to other full featured OSs. For example, RedHat Linux versions 8 and 9 are approximately 1.2 GB and Sun's Solaris 8 and 9 are approximately 665 MB. The presently preferred embodiment utilizes MSDOS in the boot image to take advantage of the large selection of vendor tools written to work with MSDOS.

In addition to the size of ramdisk available to store and run an OS and provisioning logic and data, as the proper driver has not been installed for the network device the communication speed is often such that the download time of a full-featured OS is unacceptably long. With a basic OS installed and running the target can then run logic included in the boot image, or download and run logic.

In the presently preferred embodiment the processes described in connection with FIGS. 6 through 12 use the main memory of the target computer to store programs, agents, libraries, data and executable instructions; RAMDISK is used in place of the storage device, typically a hard drive, to store the post-boot agent and other software and data. There are several advantages of using main memory in place of a storage device. One of the advantages is that a more general post-boot agent and logic may, be used, as the hard drive need not be formatted prior to the downloading and execution of an agent. The present invention allows for one post-boot agent type per microprocessor platform. Examples of common microprocessor platforms are Intel™ x86 architecture 32-bit, Intel architecture 64 bit, Sun Microsystems™ SPARC™ processors, IBM's PowerPC™ and Hewlett Packard's™ PA-RISC™.

### Preparting a Target for OS Provisioning

FIG. 7 illustrates the progression of states in preparing the target for installation of an operating system. In the presently preferred embodiment, the control agent progresses through three states in preparing the target in provisioning an OS. These states are referred to as init_1, init_2 and init_3. The first state 701, or initial state, init_1 prepares the target for receiving the OS to be provisioned. The second, or intermediate, state 702, referred to as init_2, installs and initializes software to enable full TCP/IP communication with the communications device. The third state 703, or final preparation state, init_3 authenticates the target and connects to the provisioning server.

FIG. 8 illustrates the initial state init_1 in preparing the target server. Referring now to FIG. 8, after step 606 at step 801 an automatic execution file (autoexec.bat in MSDOS) is executed in the context of the boot image and enters an initial stage of the process of provisioning an OS on the target. An automatic execution file such as autoexec.bat is a file that is used by the computer to execute instructions before the operating system is up and running. The automatic execution file is a text file that resides in the root directory in the ramdisk created by the network boot process. At step 802 the automatic execution file creates a larger RAMDISK. Then, at step 803 the automatic execution file extracts the system ID tools from the boot image and copies them to RAMDISK. At step 804 the automatic execution file switches command.com to execute from RAMDISK. At step 805 the automatic execution file extracts and executes the control agent, which ends the initial stage of preparing the target and initiates the second state, init_2. With a “basic” OS now running on the target computer the target is now in a “post-boot” process.

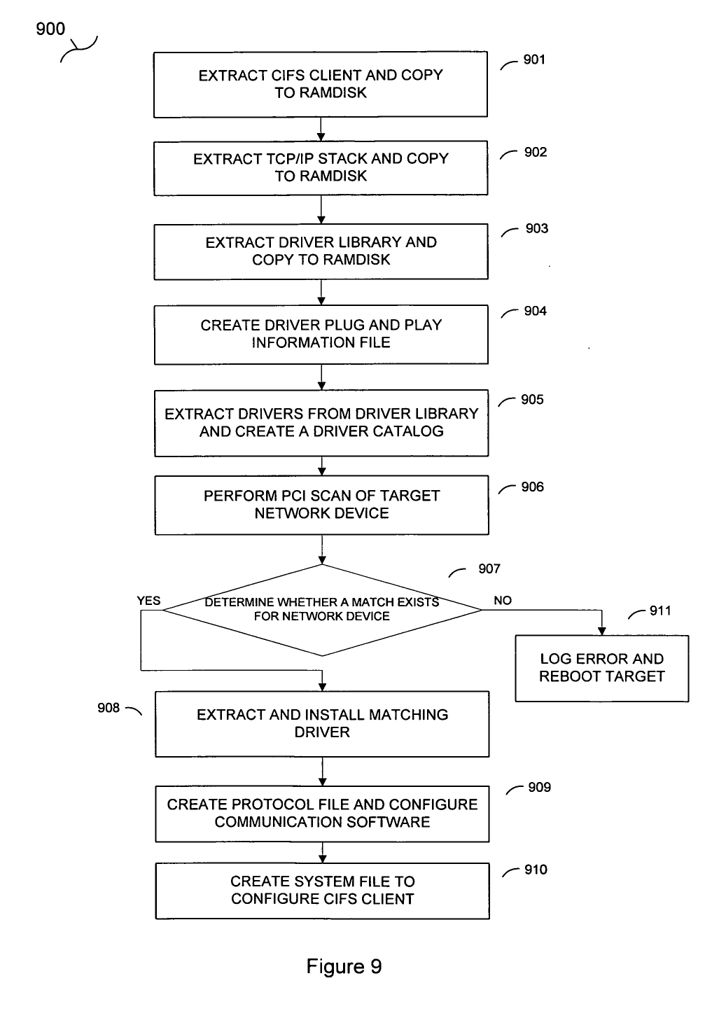

FIG. 9 illustrates the process of initializing the network device according to the second state of preparing the target server, init_2. At step 901 the control agent extracts the CIFS client from the boot image and copies it to RAMDISK (a CIFS, NFS or other network file protocol may be used in alternate embodiments of the present invention). At step 902 the control agent extracts the TCP/IP stack from the boot image and copies it to RAMDISK. At step 903 the control agent extracts the driver library from the boot image and copies it to RAMDISK. At step 904 the control agent creates a driver plug and play information file from the driver library. In the presently preferred embodiment the driver library contains three files associated with each type of driver, as illustrated by table 2. These three files make up the driver file group for a particular network device. The actual driver is included in the group as a .exe or .sys file. The device driver for the network device is typically provided by the vendor of the network device to enable full featured communication through the network device. The drivername.txt file includes PCI ID parameters that allow the system to use the results of a PCI scan of the target to identify the correct device driver to be used with the target's network device. In the presently preferred embodiment, the drivername.txt file includes the full name of the driver, for example “Broadcom 100/1000 Adapter”, as well as the name of the driver extracted from the driver.ini file provided by the network device vendor (typically with the .exe. or .sys file). The drivername.info file contains descriptive information on the device driver use by the system to install, configure or operate the device driver and network device.

TABLE 2
Driver File Group

| File extension-file name | Description |
|---|---|
| .exe (or) .sys | Device driver for the network device |
| | associated with the Driver File Group |
| drivername.txt | File containing PCI ID parameters |
| Drivername.info | File containing descriptive information |
| | on the network device |

After step 904, the control agent extracts the drivers from the driver library and creates a catalog of the drivers at step 905. At step 906 the control agent initiates a PCI scan to determine the network device installed in the target computer. The PCI scan checks the PCI bus and detects the vendor of the network device and device information. At step 907 the control agent determines the appropriate driver for the target by comparing the uses the results of the PCI scan to the driver PCI ID file and driver info file in the catalog created in step 905. If at step 907 there is a match, at step 908 the control agent extracts and installs the .exe or .sys file (the network device driver) matching the results of the PCI scan. After step 908 the control agent proceeds to step 909. If there was no match at step 907, the control agent proceeds to step 911.

At step 909 the control agent creates a protocol.ini file which is used to configure the TCP/IP stack to work with the network device. At step 910 the control agent creates a system.ini file which is used to configure the CIFS client. After step 910 state init_2 is completed and the network device has the appropriate device driver and communication software installed and configured. After step 910 and the control agent proceeds to step 1001 where state init_3 is initiated.

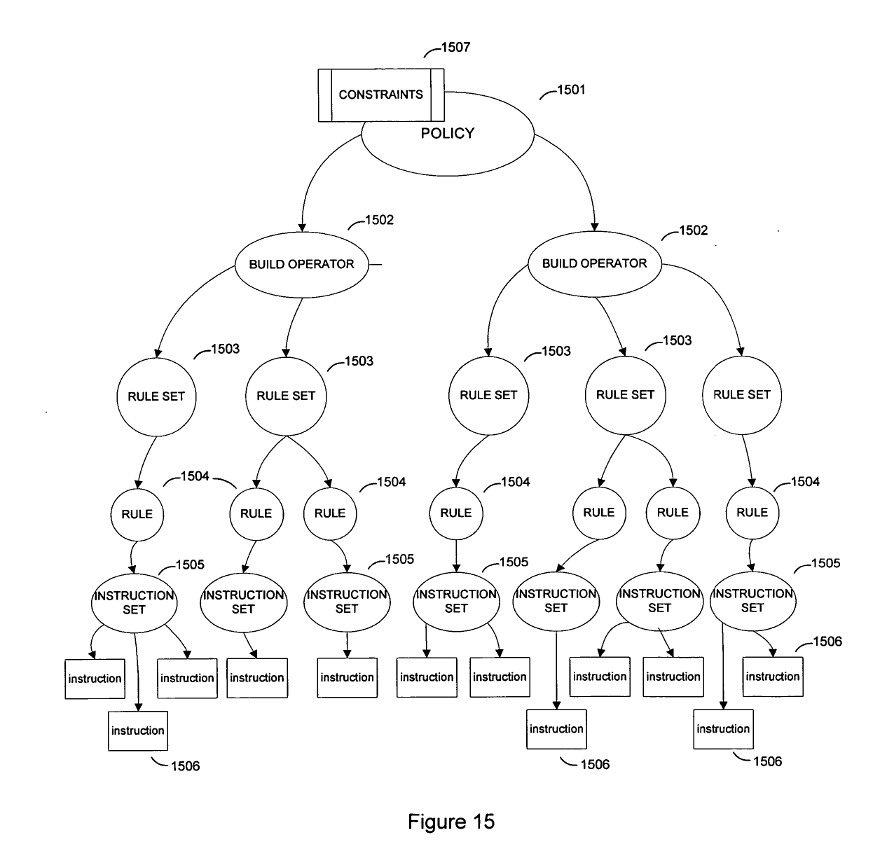

If at step 907 there was no match, at step 911 the control agent logs and error and reboots the server. In the presently preferred embodiment, the target will not be entered into the state machine discussed more fully below in reference to FIG. 15.

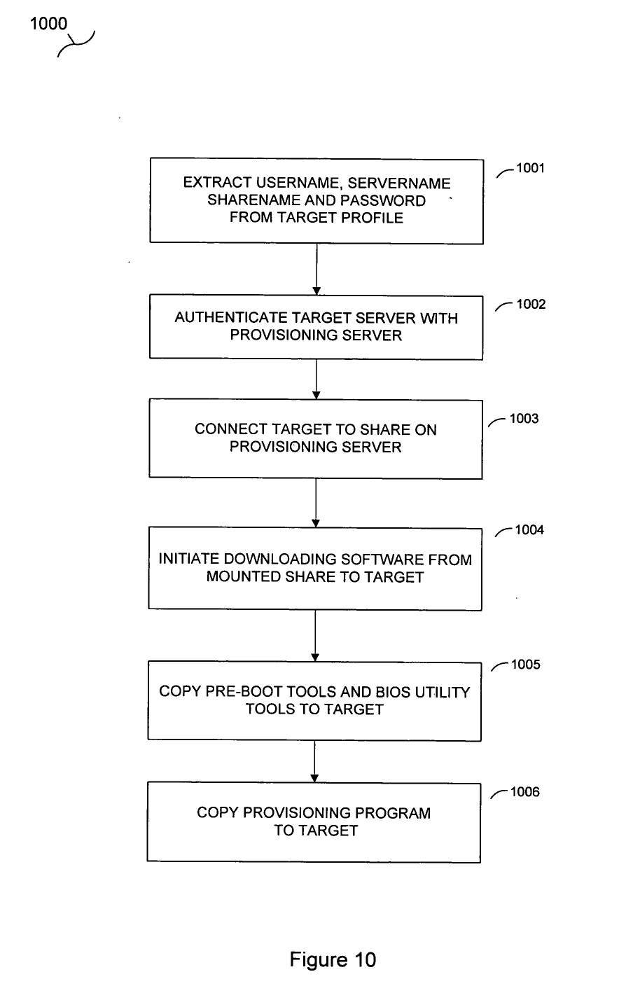

FIG. 10 illustrates the process 1000 the initial state init_3 follows in preparing the target server. At step 1001 the control agent extracts from the target profile file the username, servername, sharename and password to be used in authenticating the target server with the provisioning server. At step 1002 the control agent authenticates the target server with the provisioning server using the target profile attributes extracted in step 1001. At step 1003 the control agent connects the target to the share on the provisioning server intended for the target, using the sharename extracted in step 1001. At step 1004 the system initiates a deploy program to begin downloading software and data to the target from the mounted share of the provisioning server. At step 1005 the system copies pre-boot tools and BIOS utility programs to RAMDISK on the target. At step 1006 the system copies a provisioning program that implements the state machine to RAMDISK on the target. After step 1006 the system ends init_3 and the process of preparing the target computer for installation of the operating system is complete.

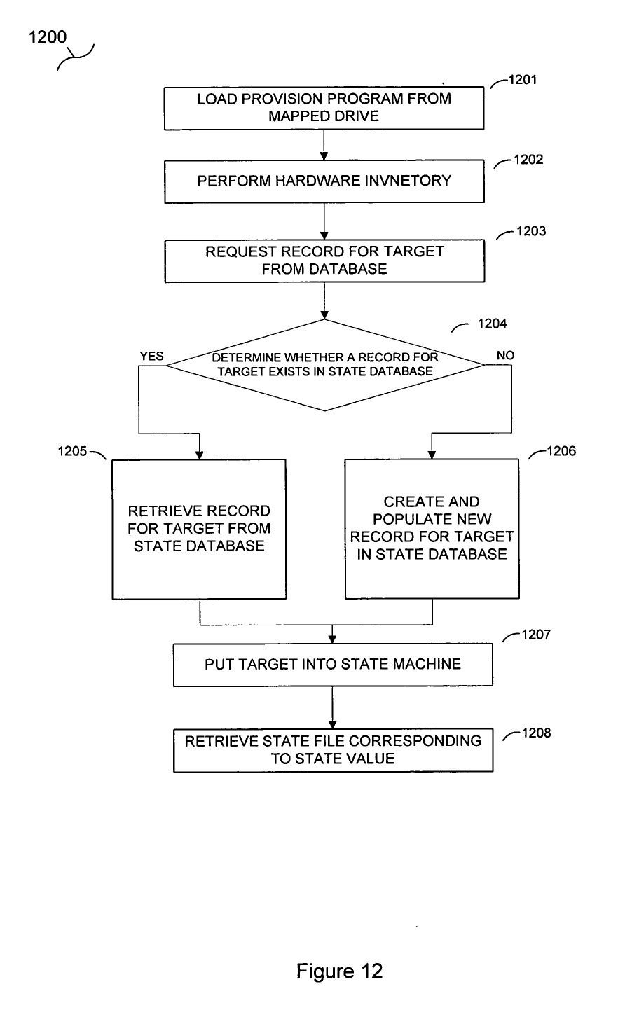

Control of the provisioning process is returned to the control agent on the target computer after step 1006 and the completion of the provisioning preparation process. The control agent then runs provisioning program, described below in reference to FIG. 12.

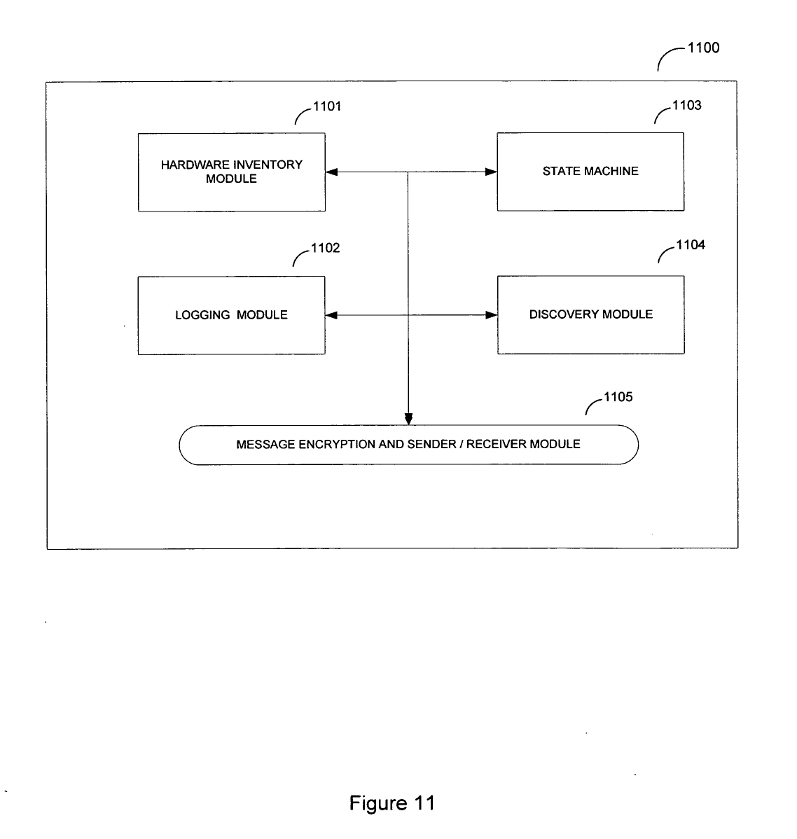

FIG. 11 is a block diagram illustrating the various software modules in the presently preferred embodiment of provisioning program 1100 provisioning program 1100 includes a HW inventory module 1101, a logging module 1102 to log the activities of the provisioning, discovery and management process, a state machine 1103 (described more fully below in connection with FIG. 15), a discover module 1104 and a message sender/receiver module 1105. The message sender/receiver module connects to the provisioning server described below in connection with FIG. 12.

FIG. 12 illustrates the process 1200 followed by provisioning program in provisioning and OS on the target computer. At step 1201 provisioning program is initiated by the control agent. Typically, this will happen after step 1006 and the completion of the preparation of the target server, but may be initiated at any time by the control agent. At step 1202 the provisioning program performs a hardware inventory to identify key attributes of the target computer. The vendor, model and MAC have already been discovered during the pre-boot process. Additional target attributes were discovered during init_2 where the network device was scanned prior to the installation and configuration of communications drivers and software. Additional hardware attributes discovered during step 1202 include the entire physical hardware inventory of the device, which includes, without limitation, the following components: BIOS, system motherboard, chassis, processor, cache, ports, system slots, system memory, memory devices, memory summary, BUS inventory, storage inventory, and the disk masterboot record inventory. The results of the hardware inventory are stored in RAMDISK and passed back to the provisioning server. The results of the hardware inventory are also converted into an XML document called SYSTEMS.XML that may be used by the provisioning system for checking conditions or by other systems to make a decision on the hardware inventory of the device. An example SYSTEMS.XML file and example hardware inventory log are described below in connection with Example 2. At step 1203 provisioning program requests from the database of the provisioning server a record corresponding to the target. As the control agent already determined the vendor, model and MAC of the target during init_1, any or all of these values may be passed to the provisioning server to request a record corresponding to the target computer. In the presently preferred embodiment, all three of these values are passed to the target during step 1203 with the MAC address serving as a unique identifier for the target computer. The provisioning server responds to the request for a record and at step 1204 the system determines whether a record exists for the target server. At step 1204 the system checks the discovery store for key attributes passed during step 1203, and the system has a record for the target in the state database. If at step 1204 it is determined that there is a record for the target, the system proceeds to step 1205 where the record is retrieved from the database. After step 1205 the system proceeds to step 1207. If at step 1204 it is determined that there isn't a record for the target, the system creates a new record in the discovery and state database at step 1206 and populates the state field with State=0. Also as part of step 1206, the system creates a new record in the inventory store of the discovery database and populates the file SYSTEMS.XML (described below) with the results of the hardware inventory of the target. After step 1206 the system proceeds to step 1207.

At step 1207 the state value from the record corresponding to the target is passed to provisioning program, which enters the target into the state machine by passing the state value to the state machine. After the target has been put into the state machine at step 1207, the provisioning program retrieves the state file corresponding to the state value at step 1208. In the presently preferred embodiment, the state file retrieved at step 1208 is not required to be conditional on the hardware attributes discovered at step 1208. After step 1208 the system proceeds to step 1301.

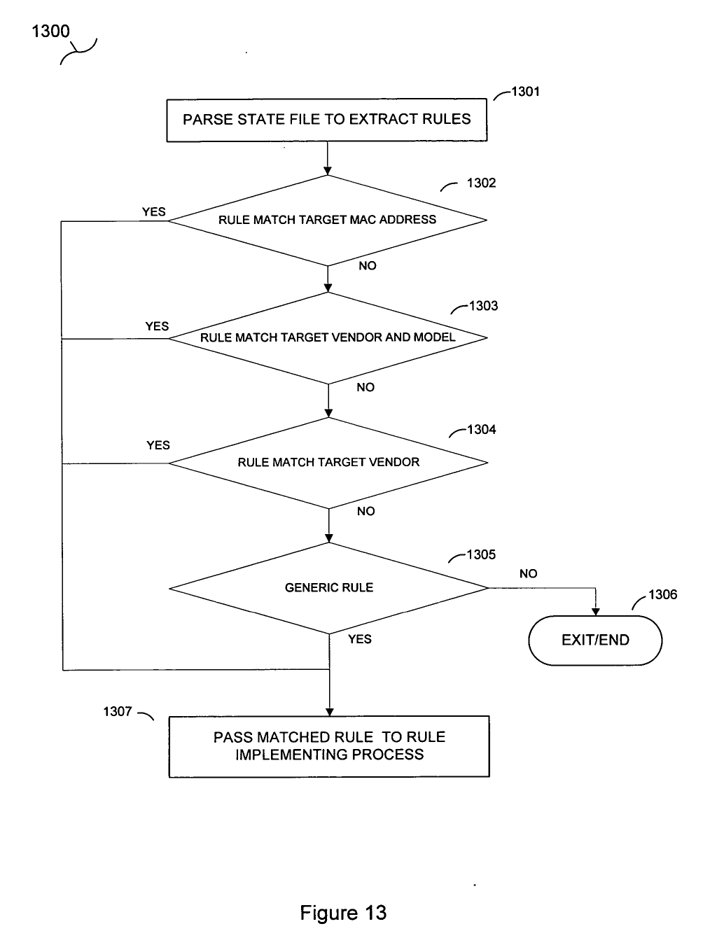

FIG. 13 illustrates the process 1300 the provisioning program follows to select an appropriate rule from the state file received at step 1208. At step 1301 the provisioning program parses the state file corresponding to that state to identify the rules contained within that state file. At step 1302 the provisioning program uses the MAC address of the target to determine whether any of the rules identified at step 1301 match the MAC address of the target. If a match is found at step 1302, the provisioning program proceeds to step 1307. If no match is found at step 1302, the provisioning program proceeds to step 1303.

At step 1303 the provisioning program uses the vendor and model of the target computer to determine whether any of the rules identified at step 1301 match the vendor and model of the target. If a match is found at step 1303, the provisioning program proceeds to step 1307. If no match is found at step 1303, the provisioning program proceeds to step 1304.

At step 1304 the provisioning program uses the vendor of the target computer to determine whether any of the rules identified at step 1301 match the vendor of the target. If a match is found at step 1304, the provisioning program proceeds to step 1307. If no match is found at step 1304, the provisioning program proceeds to step 1305.

At step 1305 the provisioning program determines whether any of the rules identified at step 1301 are applicable to a generic target computer. As described more fully below, rules can have “null” attributes allowing any computer to satisfy the requirements. Such rules apply to any generic computer. If a match is found at step 1305, the provisioning program proceeds to step 1307. If no match is found at step 1305, the provisioning program logs an error at step 1306. In the presently preferred embodiment of the present invention, this condition is prevented from occurring as the provisioning system will always have a default rule for every state (included in each state file) that either logs an error or raises and alert or performs a default provisioning rule for that state applicable to all types of devices.

At step 1307 the control agent passes the matched rule from one of the prior determining steps to step 1401 of process 1401.

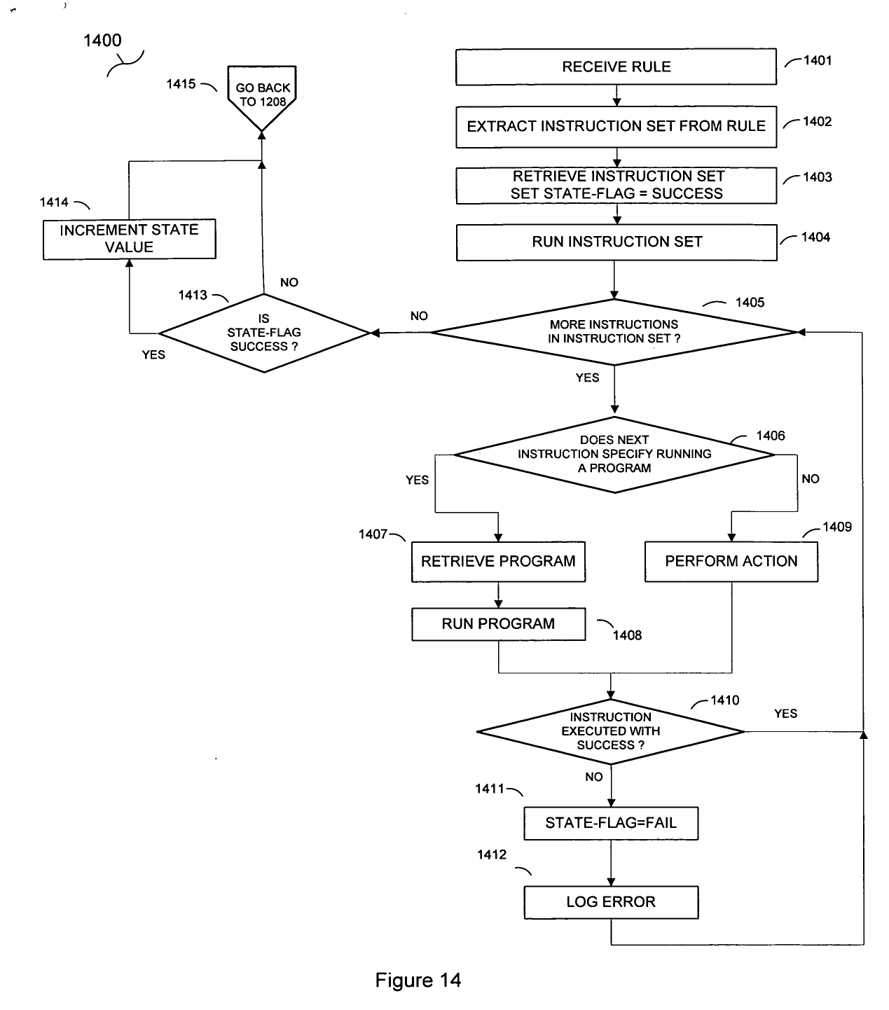

FIG. 14 illustrates the process 1400 of implementing instructions from a rule. At step 1401 the rule selected during process 1300 is received from step 1307. At step 1402 the provisioning program extracts the name of the instruction set and the instruction set locator, identifying where the system should look to recover the instruction set. The provisioning program then proceeds to step 1403 where the instruction set is retrieved according to the instruction set locator extracted at step 1402. Typically, the locator will point to a location on the network, and download the instruction set from the network using CIFS, NTF, HTTP or any network based communication protocol the control agent is configured for. Alternatively, the location could point to an instruction on some other sever or network, for example, the provisioning server, or even to a location on the target computer. During his step the provisioning program also sets the STATE-FLAG to SUCCESS in order to mark successful execution of this state. This STATE-FLAG is set to FAIL by the provisioning program, if any instructions in the instruction set fails or returns a return code that is not a success.

After downloading the instruction set at step 1403 the provisioning program runs the instruction set at step 1404. As discussed more fully below in connection with Example 1, instruction sets are executable logic or vendor utilities or tools. The executable logic may be either a program or, in the presently preferred embodiment, a script. After step 1404 the provisioning program proceeds to step 1405 where the provisioning program determines if there are any instructions in the instruction set. If at step 1405 the provisioning program determines that there are additional instructions the provisioning program extracts the instruction and proceeds to step 1406. If, at step 1405, the provisioning program determines that there are no additional instructions the provisioning program proceeds to step 1413.

Instructions can implement many different actions to be taken on the target. The actions could identify a specific action, such as rebooting the target server, or it could identify a particular program to run. In the event of identifying a particular program, the instruction will specify the location and name of the program. Typically, the programs identified in the preferred embodiment of the invention are vendor tools used in provisioning servers.

After step 1405 the provisioning program proceeds to step 1406 where a determination is made as to whether the instruction specifies running a program such as a vendor tool. If the instruction does specify running a program, then the provisioning program proceeds to step 1407 where the program is retrieved. The provisioning program then runs the program at step 1408. After step 1408 the provisioning program proceeds to step 1410.

If at step 1406 the determination is made that the instruction does not require running a program, then the provisioning program proceeds to step 1409 where the action specified by the instruction is carried out. After step 1408 the provisioning program proceeds to step 1410.

At step 1410 the provisioning program uses the return code of the action performed or the program run to determine whether the instruction was executed successfully. If at step 1410 the provisioning program determines the instruction was executed successfully, the provisioning program returns to step 1405. If at step 1405 the provisioning program determines that the instruction was not executed successfully, the provisioning program proceeds to step 1411.

At step 1411 to sets the STATE-FLAG to FAIL the provisioning program then proceeds to step 1412, where a log of the error encountered, return code and the instruction that failed is logged on the provisioning system. The provisioning program then returns to step 1405.

At step 1413, the provisioning program determines whether there has been a failure during the execution of any provisioning instructions by checking the STATE-FLAG. If at step 1413 the STATE-FLAG indicates that all the prior executed rules were executed successfully (STATE-FLAG is SUCCESS), then the provisioning program proceeds to step 1414 where the state value is incremented. After step 1415 the provisioning program proceeds to step 1415 and returns to step 1208 of process 1200, where the state file corresponding to the state value is retrieved and put into process 1300 where the appropriate rule is selected from the state file.

If at step 1413 the STATE-FLAG indicates that at least one of the prior executed rules were not executed successfully (STATE-FLAG is FAIL), then the provisioning program proceeds to step 1415 and returns to step 1208.

### Provisioning Rules

In the presently preferred embodiment, each state is associated with an XML file that holds a single ruleset. Rulesets may hold multiple rules that are defined according to attributes such as vendor, model and MAC address. Rules contain instruction set along with an instruction location identifier indicating the location of the corresponding instruction set. Each instruction set can hold any number of Instructions. The nine provisioning states in the presently preferred embodiment are shown below in Table 3 implemented as a ruleset.

TABLE 3

| | | XML File containing the |
|---|---|---|
| State | Description | ruleset for this state |
| 0 | Hardware Identification/BIOS | HRDW.XML |
| | update | |
| 1 | H/W and RAID Configuration | CFG.XML |
| 2 | Pre-Cloning | CLONE0.XML |
| 3 | Cloning - imaging | CLONE1.XML |
| 4 | Post-Cloning | CLONE2.XML |
| 5 | Pre-Installation | INSTALL0.XML |
| 6 | Installation | INSTALL1.XML |
| 7 | Post-Installation | INSTALL2.XML |
| 8 | DEVICE PROVISIONED | ------ (no file is required, |
| | | STATE.XML will have |
| | | state = 8 for device) |
| 100 + | Take Snapshot | SNAP.XML |
| AnyState | | |

A ninth state, the snapshot state, creates an image (or “snapshot”) of the storage device of the target, along with any other pertinent information and stores the image on the provisioning server. As shown in Table 3, the presently preferred embodiment has two finite states for hardware configuration which are states 0 and 1, three finite steps for OS installation through unattended installation which are states 5, 6, and 7, and three finite steps for image based OS installation in states 2, 3 and 4 respectively.

The state machine retrieves the appropriate XML file from the state database based on the state value corresponding to the XML file. In the present example, the state value is equal to zero (State=0) and the state machine retrieves the XML file corresponding to State=0, which is HRDW.XML.

The present invention uses rules-based logic to encapsulate the best practices of provisioning a target. By using rules, implemented by a state machine, the present invention is able to use existing vendor tools as well as incorporate best practices into an automated provisioning system. Vendor tools are the programs and executable instructions vendors make available for the provisioning and management of the computers they sell. Vendor tools perform a wide variety of configuration, inventory, installation and management tasks such as formatting hard drives, configuring hardware, configuring RAID controllers, configuring software, inventory hardware, install software, un-install software, etc. Additionally, the present invention provides flexibility in allowing new tools and updates to best practices to readily and easily be incorporated into the automated provisioning system of the present invention. As rules are implemented with XML files it is relatively easily to modify rules to allow for changes in vendor tools, changes in best practices, or changes due to the preferences of those using the provisioning system. Additionally, the use of rules allows for creation of custom provisioning logic to suit the particular application of the provisioning system.

Provision rules allow several levels of specificity in providing instructions the provisioning system. Rules allow individual targets to be specified for special treatment. Additionally, a rule can be general to cover all possible targets. More commonly, rules provide instructions on how the system is to process a make or model. The present invention is described more fully below in Example 1, which provides a set of rules for a Compaq model ProliantDL360G2 target server to be provisioned with Microsoft's Windows 2000 operating system. 10 Policies are collections of build operators applied under a set of constraints to a device. A build operator is a collection of rules represented by similar attributes (such as Vendor, Model and MAC address) in one or more rule sets. Different rule sets define a different provisioning state. In effect, a policy is a collection of rules relating to how to provision a target server from a particular vendor, for example Dell™ subject to fulfillment of specific constraints. There can be more than one policy for a given vendor and a policy that can contain rules for provisioning any type of device with a certain piece of software. Additionally, policies can have greater specificity than just vendor, by, for example, also being specific for a particular model or other attribute of the target. Policies are uniquely named, indexed, and in the presently preferred embodiment use a naming structure that uniquely identifies the vendor the policy is applicable to.

Groups, as used in the present application, are the collection of target computers that a policy is applied to. For example, a Policy that is applicable to all Dell servers would have as its related group all models of dell servers. Another example is a policy that provisions a group of server from three different vendors with a piece of software where this policy contains the rules specific for the software for each of those vendors and types of servers. If the Policy were more focused, for example all Dell 2205 servers, then the groups would also be more focused as only Dell model 2205 servers. Both policies and groups may also be more specific than vendor model, for example specifying different makes and models with a certain type of hard drive, RAID cards, memory capacity and CPU type, number and speed.

In order to provide better understanding of the operations of the present invention, an actual example of the policies and rules for a specific model of server is provided below in Example 1.

### EXAMPLE 1

The present example uses a typical company with multiple departments, such as marketing, sales, finance and IT, having multiple servers dedicated to specific departments within the company.

Group 1 has six servers whose primary purpose is to run software for the company's marketing department. Unless noted as otherwise, each of the six marketing servers has 1 GB RAM, 80GB hard drive and an Intel Pentium™ 4 2.4 GHz processor. The six servers consist of:
Two Dell™ 2550 (One Dell 2550 has 256 MB RAM)
One Compaq™ ProliantDL360G2™
One IBM® Netfinity™ 6000
One server called “WhiteBox1” assembled from off the shelf components.

Group 2 consists of four servers dedicated to the information technology (IT) department. Unless noted as otherwise, each of the six marketing servers has 1 GB RAM, 80 GB hard drive and an Intel Pentium™ 4 2.4 GHz processor. The four servers for group 2 consist of:
Two Dell 2550
Two Compaq ProliantDL360G2

The present example includes four policies. Policy 1 is named “The Windows XP for Marketing” policy. Policy 2 is named “Red Hat Linux 9 Policy for IT” policy. Policy 3 is named “Marketing Software” policy and Policy 4 is named “IT software” policy.

The present example includes twelve build operators. Four build operators are hardware build operators, six of the build operators are operating system build operators, and two build operators are application software build operators. The twelve build operators are:
HWBuildOperator1: Build operators to configure Dell 2550 (BIOS, RAID, DISKS) using vendor hardware tools
HWBuildOperator2: Build operators to configure Compaq DL360G2 (BIOS, RAID, DISKS) using vendor hardware tools
HWBuildOperator3: Build operators to configure IBM Netfinity 6000 (BIOS, RAID, DISKS) using vendor hardware tools
HWBuildOperator4: Build operators to configure the WhiteBox1 (BIOS, RAID, DISKS) using off the shelf hardware tools provided by the vendors of the hardware components.
OSBuildOperator1: Build operators to install Windows XP with Dell vendor drivers from Dell for Dell model 2550
OSBuildOperator2: Build operators to install Windows XP with vendor drivers from Compaq for Compaq DL360G2
OSBuildOperator3: Build operators to install Windows XP with vendor drivers from IBM for IBM Netfinity 6000
OSBuildOperator4: Build operators to install Windows XP with vendor drivers from various component manufacturers for WhiteBox1
OSBuildOperator5: Build operators to install RedHat Linux 9 with vendor drivers from Dell for Dell model 2550
OSBuildOperator6: Build operators to install RedHat Linux 9 with vendor drivers from Compaq for Compaq DL360G2
APPBuildOperator1: Build operators to install all marketing software (MS Office XP, SalesForce Client Software, Virtual Presentation Client Software, Expense Report Tool, Dekstop Favourites and Printers) on Windows XP
APPBuildOperator2: Build operators to install all IT software (OpenOffice 1.2, Linux Packet Sniffing tools, Apache Web Server, Expense reporting tool, Java Software Development Kit 1.4.2, Unix PowerTools, Adobe Acrobat reader for Linux) on Linux 9.

The twelve build operators above are used to create four policies with one constraint. The relationship between the twelve build operators, one constraint (described below), and the four policies described above are:
Policy 1=(HWBuildOperator1+HWBuildOperator2+HWBuildOperator3+HWBuildOperator4)+(OSBuildOperator1+OSBuildOperator2+OSBuildOperator3+OSBuildOperator4)+Constraint 1
Policy 2=(HWBuildOperator1+HWBuildOperator 2)+(OSBuildOperator5+OSBuildOperator 6)+Constraint 1
Policy 3=(APPBuildOperator1)+Constraint 1
Policy 4=(APPBuildOperator2)+Constraint 1

In the conventions of the present application, the use of the “+” operator in Policies 1 and 2 is used to indicate that contained within the corresponding policy is all the build operators joined by the “+” operator, the actual operation and use of a policy and the build operators within the policy is described below.

The one, and only, constraint in the present example is:
Constraint 1=RAM>=512 MB, Hard Disk Size>=20 GB, Processor>=Pentium 3, Processor Speed>=1000 Hz.

An administrator wishing to provision the marketing servers corresponding to Group 1 would apply Policy 1 and Policy 3 subject to Constraint 1. Policy 1 contains all the build operators sufficient to configure the hardware of Group 1 and provision the appropriate OS and drivers for Group 1. Note that in the present example, Policy 1 allows configuration and installation of all software for Policy 3 and Policy 2 allows for configuration and installation of all software in Policy 4. Alternate embodiments of the present invention could tie policies related to hardware configuration and OS installation and configuration to application policies.

As Group 1 includes four different types of servers, specifically a Dell 2550, a Compaq DL360G2, an IBM Netfinity 6000 and one “white box” server, then all four hardware configuration build operators would be used. Additionally, as the servers are to be used as marketing servers, then AppBuildOperator1 would be used by the administrator to install the software for the marketing department. As AppBuildOperator1 provisions application software designed to run on Windows XP, OS build operators 1 through 4 (OSBuildOperator1, OSBuildOperator2, OSBuildOperator3, and OSBuildOperator4) would be used to provision Windows XP on the servers of Group 1. As stated above, Policy 1 and Policy 3 would be used by the administrator, subject to Constraint 1.

The administrator provides instructions to the provisioning server, either through a command line interface (CLI), a graphical user interface (GUI) or through passing or uploading data or variables (for example from another computer system or a database). The provisioning server collects the server computers that satisfy Group 1. Typically, as shown in FIG. 1, the provisioning server is in an environment, such as a data center, where there are multiple target servers. The collection of the server computers to set a target group that satisfies Group 1 may involve the provisioning server checking the database to determine which servers in the environment satisfy the make, model and other criteria necessary for designation as a target server for Group 1. If necessary, the present invention may query the servers in the environment to collect the necessary information to assemble a collection of target servers for Group 1, as described above in connection with the discovery process. Alternatively, the administrator may manually designate those servers to include in Group 1. Additionally, the system may select from the servers in Group 1, or the Administrator may specify which of the servers in Group 1 is to be the target at a given stage. While the present example describes one target being provisioned at a time, this is done for illustration purposes only, as the present invention is equally applicable of provisioning multiple targets at once in a multi-threaded manner.

Once the collection of servers is obtained, the provisioning server applies the conditions in Constraint 1, to filter out devices that do not satisfy the requirements of the constraint.

As described above in connection with FIG. 14, the provisioning program resolves from the rules the specific tools to be used, the order in which the tools are to be used, and any information to be passed to the target or used in installing software or configuring software or hardware. As shown below, HWBuildOperator2 is a collection of instructions in several state files, which are implemented as XML files, and contains make, model and other information for the provisioning server to use in extracting information on how to provision the target. Specifically, HWBuildOperator2 has two rule sets, implemented as state files HRDW.XML and CFG.XML, which contain:

HRDW.XML

| | |
|---|---|
| 1 | <?xml version=“1.0” encoding=“UTF-8”?> |
| 2 | <!-- Verbatix 2.1 System Rules --> |
| 3 | <!-- This Document contains 2 Rules --> |
| 4 | <RULESET> |

| 5 | <RULE> | | | |
|---|---|---|---|---|
| 6 | <Target Vendor=“ | ” Model=“ | ” MAC=“ | ” /> |

| | |
|---|---|
| 7 | <Locale>%_NETDRIVE%\Tools\</Locale> |
| 8 | <Command>REBOOT</Command> |
| 9 | </RULE> |

| | |
|---|---|
| 10 | <RULE> |

| | |
|---|---|
| 11 | <Target Vendor=“Compaq” Model=“ProLiantDL360G2” MAC=“00-08-02-A2-5A-20” /> |
| 12 | <Locale>%_NETDRIVE%:\vendor\Compaq\W2K\scripts\DL360G2\</Locale> |
| 13 | <Command>hrdw.bat</Command> |

| | |
|---|---|
| 14 | </RULE> |

| | |
|---|---|
| 15 | </RULESET> |

CFG.XML

| | |
|---|---|
| 1 | <?xml version=“1.0” encoding=“UTF-8”?> |
| 2 | <!-- Verbatix 2.1 System Rules --> |

| | |
|---|---|
| 3 | <!-- This Document contains 2 Rules --> |
| 4 | <RULESET> |
| 5 | <RULE> |

| | | | | |
|---|---|---|---|---|
| 6 | <Target Vendor=“ | ” Model=“ | ” MAC=“ | ” /> |

| | |
|---|---|
| 7 | <Locale>%_NETDRIVE%\Tools\</Locale> |
| 8 | <Command>REBOOT</Command> |

| | |
|---|---|
| 9 | </RULE> |

| | |
|---|---|
| 10 | <RULE> |
| 11 | <Target Vendor=“Compaq” Model=“ProLiantDL360G2” MAC=“00-08-02-A2-5A-20”/> |
| 12 | <Locale>%_NETDRIVE%:\:\vendor\Compaq\W2K\scripts\DL360G2\</Locale> |
| 13 | <Command>cfg.bat</Command> |

| | |
|---|---|
| 14 | </RULE> |

| | |
|---|---|
| 15 | </RULESET> |

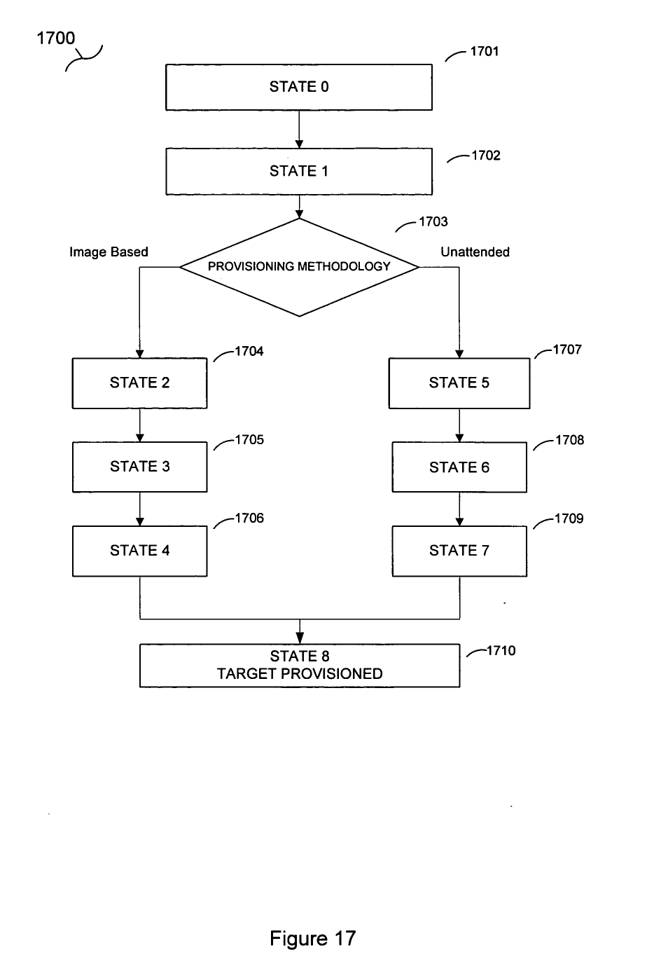

As described more fully below in connection with FIG. 17 describing the state machine of the present invention, rule set HRDW.XML is associated with state zero and rule set CFG.XML is associated with state one.

The provisioning program parses the state files associated with HWBuildOperator2 in provisioning the target. More particularly, which state file is parsed at a given instance, and in what order the state files are parsed, is determined by the state machine described below. When the state machine is in state zero, the provisioning program parses the HRDW.XML file to retrieve the provisioning instructions relevant for the specific target. As stated within HRDW.XML at line 3 (the lines in the example XML files and other code or script examples are for illustration purposes only, and are generally not included in actual implementations of the present invention) HDWR.XML contains two rules, as illustrated by the two sets of <RULE> and </RULE> tags. In the present example, where the target currently being provisioned by the provisioning server is one of the Compaq Proliant DL360's, the provisioning server compares the attributes of the target against the rules identified by the tags at lines 6 and 11, and uses the rule associated with line 11. Line 11 includes several criteria the target needs to meet for the rule associated with line 11 to be used by the provisioning server. Specifically, line 11 has the attributes, or conditions, of the vendor being a Compaq, the model being a ProLiantDL360G2, and the MAC address of the server being 00-08-02-A2-5A-20. As stated above, rules may be specific to a specific target server, as indicated by the MAC address, or may be more general applying to a particular server or group of servers. In the presently preferred embodiment, rules include three inclusion, or positive, attributes which relate to the vendor, model and MAC address of the target computer. The use of these three rule attributes allows the provisioning of the majority of computers using vendor tools and incorporating best practices in the use of vendor tools in provisioning computers. Alternative embodiments of the present invention could use more or fewer rule attributes, and may include other attributes of target computers including device serial numbers, asset tag, Globally Unique Identifiers, System ID numbers, Motherboard serial numbers, device manufacturer, device version and name, device revision number or any combination of such attributes.

An administrator may tailor the provisioning process to any subset of a group of servers through applying rules and constraints. As shown above with Constraint 1, which lists the constraint criteria of RAM greater than or equal to 512 MB, Hard Disk Size greater than or equal to 20 GB, Processor greater than or equal to Pentium 3, and Processor Speed greater than or equal to 1000 Hz. Thus, any target where the system applies Constraint 1 would exclude a target with the having the corresponding negative, or exclusion, attributes of RAM less than 512 MB, Hard Disk Size less than 20 GB, Processor less than Pentium 3, and Processor Speed less than 1000 Hz. In the presently preferred embodiment, constraints may use any number or combination of target attributes to exclude a given target or subset of targets from a group. Thus, in combination with the inclusion attributes of rules, the exclusion attributes of policies (implemented in constraints) allow an administrator to provision any subset of a group without concern that the system will provision a given server or specified subset of servers that the administrator does not want to be provisioning. This ability to exclude subsets using the inclusion and exclusion attributes of rules is in addition to the application of managed states stored in the state and discovery database which automatically exclude computers according to the conditions described above.

The rule associated with line 11 is specified by two specific identifiers indicating the location of the provisioning instructions, and the name of the file to execute to implement the provisioning instructions. The location of the provisioning instructions is contained in line 12, between the <Locale> and </Locale> tags, indicating the provisioning server should look for the provisioning instructions at
%_NETDRIVE %:\vendor\Compaq\W2K\scripts\DL360G2

where %_NETDRIVE % is a variable which refers to the drive in the provisioning system, which is mounted by the target device as the Z drive from the file server (typically, but not necessarily, running on the Provisioning Server). This locale can also refer, without limitation, to an HTTP Server address, FTP server address, NFS mountpoint or a wireless access point address. Additionally, at line 13, between the <Command> and </Command> tags is the name of the instruction set, or instruction file, the provisioning server is to execute at the location specified above, the instruction set being hrdw.bat. In the presently preferred embodiment hrdw.bat is a a script containing additional instructions, which the provisioning server would execute. While instruction sets may be programs, in the presently preferred embodiment they are implemented as scripts with run in the provisioning program on the target server. The contents of the script hrdw.bat are:

hrdw.bat

| 1 | @echo off | |
|---|---|---|
| 2 | echo | Executing Hardware rules... |
| 3 | echo | Loading BIOS settings... |
| 4 | lh %_NETDRIVE%:\vendor\compaq\bin\conrep -L | |
| | %_NETDRIVE%:\vendor\compaq\configs\dl360G2.0L | |
| 5 | echo | DONE... |
| 6 | echo | Configuring Array Controller... |
| 7 | lh %_NETDRIVE%:\vendor\compaq\bin\acr /i | |
| | %_NETDRIVE%:\vendor\compaq\configs\dl360G2.ary [symbol] | |
| /o | | |
| 8 | echo | DONE... |

| | | |
|---|---|---|
| 9 | echo | Hardware rules completed |

Running script hrdw.bat the provisioning server executes the first of the 9 instructions contained within the instruction set hrdw.bat, which is to turn echo off. Progressively it proceeds to line 4 where a vendor utility tool conrep.exe is specified. Line 4 also specifies the location of the utility tool. In the present example, utility tool conrep.exe configures the BIOS of the Compaq ProliantDL360G2. After using the utility tool conrep.exe, the provisioning server proceeds through lines 5 and 6 to line 7 where it uses vendor utility tool acr.exe, specified as acr within line 7. The utility tool acr.exe configures the array controller of the Compaq ProliantDL360G2. After using the utility tool acr.exe the script proceeds throught lines 8 and ends with line 9. Each execution of the instruction returns success , failure or other return code to the provisioning program, based on which the provisioning program continues in the process of provisioning the Compaq ProliantDL360G2.

Similar to HRDW.XML, CFG.XML is parsed by the provisioning program to determine the instructions it is to use in provisioning the target. When the state machine is in state one, the provisioning server parses the CFG.XML file to retrieve the provisioning instructions relevant for the specific target. As stated at line 3 CFG.XML contains two rules, as illustrated by the two sets of <RULE> and </RULE> tags. In the present example, where the target currently being provisioned by the provisioning server is one of the Compaq Proliant DL360's, the provisioning server compares the attributes of the target against the rules identified by the tags at lines 6 and 11, and uses the rule associated with line 11. Line 11 includes several criteria the target needs to meet for the rule associated with line 11 to be used by the provisioning server. Specifically, line 11 has the conditions of the vendor being a Compaq, the model being a ProLiantDL360G2, and the MAC address of the server being 00-08-02-A2-5A-20. As stated above, rules may be specific to a specific target server, as indicated by the MAC address, or may be more general applying to a particular server or group of servers. The rule associated with line 11 is specified by two specific identifiers indicating to location to find the provisioning instructions, and the name of the file to execute to implement the provisioning instructions. The location of the provisioning instructions is contained in line 12, between the <Locale> and </Locale> tags, indicating the provisioning server should look for the provisioning instructions at
>%_NETDRIVE %:\:\vendor\Compaq\W2K\scripts\DL360G2\

Additionally, at line 13, between the <Command> and </Command> tags is the name of the instruction set the provisioning server is to execute at the location specified above, the instruction set being cfg.bat. In the present embodiment cfg.bat is a script which the provisioning server would execute. The contents of the script cfg.bat are:

cfg.bat

| 1 | @echo off | |
|---|---|---|
| 2 | echo | Executing Configuration/Partitioning rules... |
| 3 | %_NETDRIVE%:\vendor\compaq\bin\cpqdisk/w | |
| | %_NETDRIVE%:\vendor\compaq\bin\cpqfdsk.txt | |
| 4 | :_exit | |
| 5 | echo | Configuration rules completed... |

Running script cfg.bat the provisioning server implements the instructions contained within the instruction set cfg.bat. The third instruction uses vendor utility tool cpqdisk.exe specified at line 3 of cfg.bat, specified as cpqdisk in line 4. Line 4 also specifies the location of the utility tool. In the present example, utility tool cpqdisk.exe partitions the hard drive of the Compaq ProliantDL360G2. In partitioning the hard drive the utility cpqdisk.exe use the configuration information contained in the configuration file cpqfdsk.txt, also specified in line 3 as an instruction to the provisioning system. After using the utility tool cpqdisk.exe the script ends and the provisioning program gathers the return code from the instruction execution and continues in the process of provisioning the Compaq ProliantDL360G2.

Similar to HWBuildOperator2, OSBuildOperator6 is a collection of rules in several state files, which are implemented as XML files, and contains make, model and other information for the provisioning program to use in extracting instructions on how to provision the target. Specifically, OSBuildOperator6 has three state files, INSTALL0.XML, INSTALL1.XML and INSTALL2.XML, which contain:

INSTALL0.XML

| | |
|---|---|
| 1 | <?xml version=“1.0” encoding=“UTF-8”?> |
| 2 | <!-- Verbatix 2.1 System Rules --> |
| 3 | <!-- This Document contains 3 Rules --> |
| 4 | <RULESET> |

| 5 | <RULE> | | | |
|---|---|---|---|---|
| 6 | <Target Vendor=“ | ” Model=“ | ” MAC=“ | ” /> |

| | |
|---|---|
| 7 | <Locale>%_NETDRIVE%\Tools\</Locale> |
| 8 | <Command>REBOOT</Command> |

| | |
|---|---|
| 9 | </RULE> |
| 10 | <RULE> |

| | |
|---|---|
| 11 | <Target Vendor=“000000” Model=“000000” MAC=“00-00-00-00-00-00” /> |
| 12 | <Locale>DoNotRemove</Locale> |
| 13 | <Command>InitRule</Command> |

| | |
|---|---|
| 14 | </RULE> |
| 15 | <RULE> |
| 16 | <Target Vendor=“Compaq” Model=“ProLiantDL360G2” MAC=“00-08-02-A2-5A-20” /> |
| 17 | <Locale>%_NETDRIVE%\vendor\Compaq\rh\scripts\DL360G2\</Locale> |
| 18 | <Command>install0.bat</Command> |
| 19 | </RULE> |

| | |
|---|---|
| 20 | </RULESET> |

INSTALL1.XML

| | |
|---|---|
| 1 | <?xml version=“1.0” encoding=“UTF-8”?> |
| 2 | <!-- Verbatix 2.1 System Rules --> |
| 3 | <!-- This Document contains 3 Rules --> |
| 4 | <RULESET> |
| 5 | <RULE> |

| | | | | |
|---|---|---|---|---|
| 6 | <Target Vendor=“ | ” Model=“ | ” MAC=“ | ” /> |

| | |
|---|---|
| 7 | <Locale>%_NETDRIVE%\Tools\</Locale> |
| 8 | <Command>REBOOT</Command> |
| 9 | </RULE> |

| | |
|---|---|
| 10 | <RULE> |

| | |
|---|---|
| 11 | <Target Vendor=“000000” Model=“000000” MAC=“00-00-00-00-00-00” /> |
| 12 | <Locale>DoNotRemove</Locale> |
| 13 | <Command>InitRule</Command> |
| 14 | </RULE> |
| 15 | <RULE> |
| 16 | <Target Vendor=“Compaq” Model=“ProLiantDL360G2” MAC=“00-08-02-A2-5A-20” /> |
| 17 | <Locale>%_NETDRIVE%\vendor\Compaq\rh\scripts\DL360G2\</Locale> |
| 18 | <Command>install1.bat</Command> |

| | |
|---|---|
| 19 | </RULE> |
| 20 | </RULESET> |

INSTALL2.XML

| | |
|---|---|
| 1 | <?xml version=“1.0” encoding=“UTF-8”?> |
| 2 | <!-- Verbatix 2.1 System Rules --> |
| 3 | <!-- This Document contains 3 Rules --> |
| 4 | <RULESET> |
| 5 | <RULE> |

| | | | | |
|---|---|---|---|---|
| 6 | <Target Vendor=“ | ” Model=“ | ” MAC=“ | ” /> |

| | |
|---|---|
| 7 | <Locale>%_NETDRIVE%\Tools\</Locale> |
| 8 | <Command>REBOOT</Command> |

| | |
|---|---|
| 9 | </RULE> |
| 10 | <RULE> |

| | |
|---|---|
| 11 | <Target Vendor=“000000” Model=“000000” MAC=“00-00-00-00-00-00” /> |
| 12 | <Locale>DoNotRemove</Locale> |
| 13 | <Command>InitRule</Command> |

| | |
|---|---|
| 14 | </RULE> |
| 15 | <RULE> |

| | |
|---|---|
| 16 | <Target Vendor=“Compaq” Model=“ProLiantDL360G2” MAC=“00-08-02-A2-5A-20” /> |
| 17 | <Locale>%_NETDRIVE%\vendor\Compaq\rh\scripts\DL360G2\</Locale> |
| 18 | <Command>install2.bat</Command> |

| | |
|---|---|
| 19 | </RULE> |
| 20 | </RULESET> |

As described more fully below in connection with FIG. 17 describing the state machine of the present invention, INSTALL0.XML is associated with state five, INSTALL1.XML is associated with state six, and INSTALL2.XML is associated with state seven.

The provisioning program parses the state file associated with OSBuildOperator6 in provisioning the target. When the state machine is in state five, the provisioning program parses the INSTALL0.XML file to retrieve the provisioning instructions relevant for the specific target. As stated at line 3 INSTALL0.XML contains three rules, as illustrated by the two sets of <RULE> and </RULE> tags. In the present example, where the target currently being provisioned by the provisioning server is one of the Compaq Proliant DL360's, the provisioning server compares the attributes of the target against the rules identified by the tags at lines 6, 11 and 16, and uses the rule associated with line 16. Line 16 includes several criteria the target needs to meet for the rule associated with line 16 to be used by the provisioning server. Specifically, line 16 has the conditions of the vendor being a Compaq, the model being a ProLiantDL360G2, and the MAC address of the server being 00-08-02-A2-5A-20. Thus, of the three rules specified in FNSTALL0.XML, only one applies to the target server currently being provisioned, and as the provisioning system of the present invention is aware of the attributes of the target server the system only uses rule 3 specified between the <RULE> tag and end tag of lines 15 and 19 associated with the attributes specified at line 16. The rule associated with line 16 is specified by two specific identifiers indicating the location of the provisioning instructions, and the name of the file to execute to implement the provisioning instructions. The location of the provisioning instructions is contained in line 17, between the <Locale> and </Locale> tags, indicating the provisioning server should look for the provisioning instructions at
%_NETDRIVE %\vendor\Compaq\W2K\scripts\DL360G2\

Additionally, at line 18 of INSTALL0.XML, between the <Command> and </Command> tags is the name of the instruction set the provisioning program is to execute at the location specified above, the instruction file being install0.bat. In the present embodiment install0.bat is a script which the provisioning program would execute. The actual instructions of the script install0.bat are:

install0.bat

| 1 | @echo off | |
|---|---|---|
| 2 | echo | Executing Pre-OS installation rules for Linux!... |
| 3 | echo | Formatting disk... |
| 4 | %_NETDRIVE%\vendor\compaq\bin\cpqfmt C: | |
| 5 | IF ERRORLEVEL 3 goto _dskok | |
| 6 | echo | Reboot required... |

| | |
|---|---|
| 7 | %_NETDRIVE%\vendor\compaq\bin\reboot |
| 8 | goto _exit |
| 9 | :_dskok |

| | |
|---|---|
| 10 | %_NETDRIVE%\tools\sys a: c: |
| 11 | :_exit |

Running script install0.bat the provisioning program executes the instructions contained within the instruction set install0.bat. The fourth instruction uses the vendor utility tool cpqfmt.exe specified at line 4 of install0.bat, specified as cpqfmt in line 4. Line 4 also specifies the location of the utility tool. In the present example, utility tool cpqfmt.exe partitions the hard drive designated as the C drive, of the Compaq ProliantDL360G2. Line 4 of install0.bat also includes the drive identifier at the end of line 4 indicating that the vendor tool cpqfmt.exe is to be used in connection with the C drive. In running the cpqfmt.exe utility the provisioning system of the present invention passes information to the utility to specify that the C drive is the target drive of the utility. After using the utility tool cpqfmt.exe the system proceeds to line 5 where a conditional statement is implemented. The conditional statement is the second instruction to the provisioning system in the instruction set install0.bat. The conditional statement of line 5 instructs the provisioning system to line 9, identified by _dskok, if an ERRORLEVEL 3, i.e. an error message of level three, is received from the cpqfmt.exe utility. If no ERRORLEVEL 3 is received, then the system proceeds to line 7 where another instruction is specified. The instruction on line 7 within instruction set install0.bat directs the provisioning system to reboot the target server using the vendor tool reboot.exe specified in line 7. After using the utility tool reboot.exe the script ends and the provisioning server continues in the process of provisioning the Compaq ProliantDL360G2. If at line 5 an ERRORLEVEL 3 was received and the system proceeded to line 9, then the system would run the vendor utility sys.exe according to the ninth instruction of instruction set install0.bat.

As described above in connection with rule set INSTALL0.XML, the present invention allows rules to be highly specific, pertaining to a specific machine, as illustrated by rule three of INSTALL0.XML identified by line 16 of INSTALL0.XML, the implementation of using a MAC address as a unique identifier (although other embodiments of the present invention could use other attributes of a server as a unique identifier). Rules one and two of INSTALL0.XML illustrate the flexibility of the present invention as rules one and two do not relate to specific servers as the MAC address field of the rule attributes is void (i.e. MAC=” “). In determining whether a given rule in a rule set applies to a given target server, and in determining which rule to use in the event more than one rule of the rule set matches the target server, the present invention applies several logical determinants to select the most appropriate rule. If a rule attribute is void, as indicated in INSTALL0.XML line 6 and 11 as either blank between two quotation marks (e.g. “ “) the system interprets this as an open condition where any server would satisfy this condition. The present invention also uses the logical determinant of selecting the rule with the most satisfied conditions. Of the three rules of INSTALL0.XML, the Compaq ProliantDL360G2 with a MAC address of 00-08-02-A2-5A-20 satisfied all three rules. Of the criteria of rule one, specified at line 6, all three rule criteria were void. Similarly, of the criteria of rule two, specified at line 11, all three rule criteria were void. Conversely, all three of the criteria of rule three, specified at line 16, were non-void, that is they were specified in a manner to restrict the number of possible servers that would satisfy the criteria of rule three of INSTALL0.XML. Accordingly, the present invention selects rule three as the rule to use in provisioning the target server Compaq ProliantDL360G2 with a MAC address of 00-08-02-A2-5A-20 as it met a rule with more stringent criteria. The present invention allows for rule sets with cascading rule set criteria for the specific to the very general, without concern that a general rule will be applied when a more specific rule, which is more appropriate to the target server, is available. Additionally, the present invention allow for the inclusion of multiple rules of different levels of generality which provides several benefits. With multiple rules of different levels of generality there is a greater chance that an appropriate rule will be available to provision a given target server. Additionally, having a cascading rule set criteria allows for a rule to provide greater specificity an applicability to the attributes of a given target server. This allows the vendor tools and best practices most appropriate to the target server to be applied, without concern that the rule set will be to specific so as to not be able to provision a given target server.

FIG. 15 illustrates the relationship between policies, build operators, rule sets, rules, instruction sets and instructions as illustrated in Example 1. The relationship hierarchy 1500 includes policies 1501. Policies 1501 include at least one build operator 1502, and often include multiple build operators 1502, as illustrated in Example 1 where Policy 3 and Policy 4 had only one build operator (AppBuildOperator1 and AppBuildOperator2, respectively) while Policy 1 contained eight build operators and Policy 2 contained four build operators. The build operators 1502 refer to at least one rule set 1503, and typically refer to multiple rule sets as illustrated by build operator HWBuildOperator2 which refers to two rule sets: HRDW.XML and CFG.XML. In the presently preferred embodiment of the present invention, the build operator points to one and only one rule in the corresponding ruleset. The rule sets 1503 contain at least one rule 1504, and typically multiple rules 1504, as illustrated by rule sets HRDW.XML and CFG.XML which each contain two rules. In the presently preferred embodiment, the rules 1504 contain one instruction set 1505. Along with the instruction set 1505 the rule may include location information or other information for the provisioning system to locate and run the instruction set. As illustrated by rule three of rule set INSTALL0.XML, there is only one instruction set in rule three which is install0.bat. The instruction set 1505 has at least one instruction 1506, and may have multiple instructions. As illustrated by instruction set install0.bat above, which includes four instructions. As illustrated by instruction set install0.bat, the instructions can be action oriented instructions, specifying a particular action to be taken on the target server, such as rebooting the target server, or the instructions may be execution instructions specifying a vendor tool or other program to be executed, for example the vendor tool cpqfmt.exe executed from instruction set install0.bat. Instructions include any action or processes to be carried out, invoked, executed or otherwise used to change the condition of the target server in provisioning and configuring the target server.

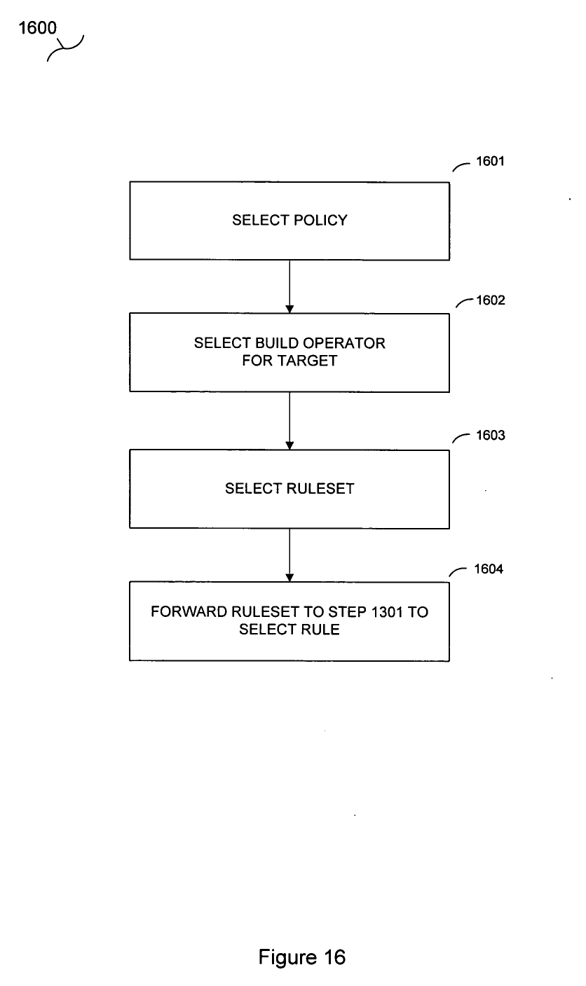

Referring now to FIG. 16, in process 1600 the provisioning server resolves the actions to be taken in provisioning the target from the policies applied to the group by the by using the attributes defined for each build operator contained in the policy. Referring to Example 1, the administrator selects Policy 2 to be applied to a group of target computers (or to an individual target computer) in step 1601. The provisioning server determines what build operators are associated with Policy 1 at step 1602 based on the target attributes, which for the Dell 2550 server of Group 1 is HardwareBuildOperator1 (HWBO1). This selection is made based on the attributes of the target server, which the provisioning server compares to the specified target attributes of the build operator.

The Hardware Build Operator1 refers to two state files, or rulesets, HRDW.XML and CFG.XML. At step 1603 the provisioning server selects the ruleset to use in provisioning based on the attributes defined in the Hardware Build Operator, namely Vendor and Model. This rule is then applied by the provisioning program running on the target server in state 0. Similarly, in state 1 the provisioning server would select CFG.XML at step 1603. After selecting the appropriate ruleset at step 1603, the system proceeds to step 1604 where the system goes to step 1301, discussed above in connection with FIG. 13, to select a rule from the ruleset.

Returning to the discussion of the provisioning the target, when the state machine is in state six, the provisioning server parses the INSTALL1.XML file to retrieve the provisioning instructions relevant for the specific target. Parsing INSTALL1.XML the provisioning system determines that of the three rules only the third rule, identified at line 16 of INSTALL1.XML applies to the current target. Line 17 includes the location information:
%_NETDRIVE %\vendor\Compaq\W2K\scripts\DL360G2\
   and line 18 includes the identifier of the instruction file to be retrieved from the instruction file location information, which is install1.bat.

In the present embodiment install1.bat is a script which the provisioning server would execute as an instruction set. The actual instructions of the script install1.bat are:

install1.bat

| 1 | @echo off | |
|---|---|---|
| 2 | echo | Executing OS Installation rule... |
| 3 | echo | Starting Linux Installation ... |
| 4 | echo | Creating startup files... |

| 5 | %_NETDRIVE%\vendor\compaq\bin\filecopy |
|---|---|
| | /s:%_NETDRIVE%\OS\rh\dosutils |
| | /d:c:\/s /e /f:*.* /p |
| 6 | %_NETDRIVE%\vendor\compaq\bin\filecopy |
| | /s:%_NETDRIVE%\vendor\compaq\rh9\DOS |
| | /d:c:\DOS /s /e /f:*.* /p |
| 7 | copy %_NETDRIVE%\OS\rh\isolinux\*.* c:\. / |
| 8 | copy %_NETDRIVE%\vendor\compaq\rh9\autoexec.bat c:\. /y |
| 9 | copy %_NETDRIVE%\vendor\compaq\rh9\config.sys c:\. /y |

| 10 | copy %_NETDRIVE%\vendor\compaq\rh9\parms.txt c:\. /y | |
|---|---|---|
| 11 | echo | DONE !... |

Running script install1.bat the provisioning program first uses vendor utility tool filecopy.exe specified at line 5 of install1.bat, specified as filecopy in line 5. Line 5 also specifies the location of the utility tool. In the present example, utility tool filecopy.exe copies the contents of a share of the drive of the file server to the hard drive of the Compaq ProliantDL360G2. Line 5 of install1.bat also includes the drive identifier indicating the precise share of the drive to be copied, which is:
NETDRIVE %\OS\rh\dosutils/d:c:\/s/e/f:*.*/p.

After using the utility tool filecopy.exe the system proceeds to line 6 where a similar instruction is implemented. Line 6 specifies using the vendor utility tool filecopy.exe. Line 6 also specifies the location of the utility tool. As above, utility tool filecopy.exe copies the contents of a share of the drive of the file server to the hard drive of the Compaq ProliantDL360G2. Line 6 of install1.bat also includes the drive identifier indicating the precise share of the drive to be copied, which is:
NETDRIVE %\vendor\compaq\rh9\DOS/d:c:\DOS/s/e/f:*.*/p

After using the utility tool filecopy.exe the system proceeds to line 7 where the system is instructed to copy the contents of the specified location to the hard drive of the target. Similar instructions are included on lines 8, 9 and 10. After executing line 10 the script ends and the provisioning program may increment the state value based on the logic in FIG. 14 and continues in the process of provisioning the Compaq ProliantDL360G2.

When the state machine is in state seven, the provisioning server parses the INSTALL2.XML file to retrieve the provisioning instructions relevant for the specific target. Parsing INSTALL2.XML the provisioning system determines that of the three rules only the third rule, identified at line 16 of INSTALL2.XML applies to the current target. Line 17 includes the location information:
%_NETDRIVE %\vendor\Compaq\W2K\scripts\DL360G2\
   and line 18 includes the identifier of the instruction file to be retrieved from the instruction file location information, which is install2.bat.

In the present embodiment install1.bat is a script which the provisioning server would execute as an instruction set. The actual instructions of the script install2.bat are:

install2.bat

| 1 | @echo off | |
|---|---|---|
| 2 | echo | Executing Post-OS Check rule... |
| 3 | REM if checksum of Linux Kernel is OK , proceed else set state | |
| | to 5 by using ‘echo 5>state.ret’ | |
| 4 | echo | Completed Post-OS Check rule... |

Running script install2.bat the provisioning server performs a checksum of the installed Linux Kernel on the target according to the instructions of line 3 of install2.bat. If the checksum is correct then the system proceeds and the script ends. At that point the target Compaq ProliantDL360G2 server has been provisioned with RedHat Linux 9 as its OS according to the specific instructions and parameters of OSBuildOperator6. However, if the checksum of the Linux Kernel is not correct, then according to line 3 of install2.bat the system changes the state variable in the state machine (described more fully below in connection with FIG. 17) to state five and exits the script install2.bat.

After the provisioning system has successfully installed an operating system on the target server, the system may proceed to provision application software on the sever. In the present example, the Administrator would use Policy 4 to install IT on Linux 9. Similarly to using Policy 1 above, the administrator would use Policy 4 which includes APPBuildOperator2 as the only build operator. As with the build operators for hardware configuring and OS installation, APPBuildOperator2 includes a hierarchy of rule sets, rules, instruction sets and instructions to install and configure the application software of APPBuildOperator2. Specifically, the hierarchy of rule sets, rules, instruction sets and instructions of APPBuildOperator2 install and configure OpenOffice 1.2, Linux Packet Sniffing tools, Apache Web Server, Expense reporting tool, Java Software Development Kit 1.4.2, Unix PowerTools, Adobe Acrobat reader for Linux on Linux 9.

Once the provisioning system has successfully completed the installation of the software associated with Policy 4 the state database is updated to indicate that the target server has been provisioned according to the provisioning system of the present invention. At that stage the provision system may either provision another target server or wait for input from an administrator or other system.

Example 1 above utilized a target server which was within the one and only constraint, Constraint 1. In the preferred embodiment of the present invention a target not satisfying one or more constraints subject to the group of target servers would pause the system and request input from an administrator (or another system if the present system is receiving instructions from another program). Alternatively, an alternate embodiment of the present invention could halt proceeding with the target that does not satisfy the constraint and either wait for input indicating another target server has been selected, or the system could choose another target server to continue the process of provisioning the group.

As can be seen from the present example, the present invention greatly simplifies the process of provisioning computers by relieving administrators from performing many of the manual tasks typically associated with software and a hardware provisioning. By using rules and policies, existing vendor tools can be leveraged to provision servers including all the required tasks of configuring hardware, installing and configuring software, determining hardware and software conditions of the target, and using attributes of the target, including its current state or past states, in provisioning. The use of rules and policies allows vendor tools to be used in a specific order, and allows specific actions to be taken between in addition to the use of vendor tools, incorporating best practices. Additionally, the use of rules and policies of the present invention provides flexibility in the use of vendor tools and best practices, allowing an administrator to modify a rule or policy, or create a new rule or policy, to provide the flexibility in provisioning servers according to the needs of the circumstances.

### EXAMPLE 2

As described above in connection with FIG. 12, the results of a hardware inventory are stored in a systems file in the state and policy database. In the presently preferred embodiment the systems file is implemented as an XML file SYSTEMS.XML. An example SYSTEMS.XML file for a Compaq Proliant DL360G2 is given:

SYSTEMS.XML

| | |
|---|---|
| 1 | <?xml version=“1.0” encoding=“UTF-8”?> |

| | |
|---|---|
| 2 | <!-- Verbatix 2.1 Discovered Systems --> |
| 3 | <!-- This Document contains 1 System --> |
| 4 | <SYSTEMSET> |

| | |
|---|---|
| 5 | <SYSTEM> |

| | |
|---|---|
| 6 | <Target Vendor=“Compaq” Model=“ProLiantDL360G2” MAC=“00-08-02- |

A2-5A-20” />

| | |
|---|---|
| 7 | <AlphaID>AAEAEUJNCA</AlphaID> |
| 8 | <NickName></NickName> |
| 9 | <MACPxe>000802A25A20</MACPxe> |

| 10 | <DiscoverTime MDY=“08-28-2003” Time=“21:04:04PM” /> | |
|---|---|---|
| 11 | <UUID>FFFFFFFFFFFFFFFFFFFFFFFFFFFFFFFF</UUID> | |
| 12 | <AssetTag> | </AssetTag> |

| | | |
|---|---|---|
| 13 | <ChassisSN> | </ChassisSN> |

| | |
|---|---|
| 14 | <MotherBrdSN></MotherBrdSN> |

| | |
|---|---|
| 15 | <ChassisMFG></ChassisMFG> |

| | |
|---|---|
| 16 | <BIOS Vendor=“Compaq” Version=“P26” Date=“06/25/2002” /> |
| 17 | <MemoryKB>262144</MemoryKB> |

| | |
|---|---|
| 18 | <MemoryMB>256</MemoryMB> |

| | |
|---|---|
| 19 | <ECCType>Single-bit ECC</ECCType> |

| | |
|---|---|
| 20 | <CPU_Count>1</CPU_Count> |
| 21 | <HardDrives>1</HardDrives> |
| 22 | <BootableHD>YES</BootableHD> |

| | |
|---|---|
| 23 | <HasRAID>YES</HasRAID> |

| | |
|---|---|
| 24 | <NICMACs>2</NICMACs> |
| 25 | <Processors> |

| | |
|---|---|
| 26 | <CPU Vendor=“Intel” Model=“Pentium III” CPUID=“6B4h” |

| | |
|---|---|
| 27 | Speed=“1400” MaxSpeed=“1660” |
| 28 | Version=“” /> |

| | |
|---|---|
| 29 | </Processors> |
| 30 | <RAID> |

| | |
|---|---|
| 31 | <RAIDController Vendor=“Compaq” |

| | |
|---|---|
| 32 | Device=“Smart Array 5i Card” |
| 33 | SubVendorID=“0E11” SubSystemID=“4080” SubUnits=“0” /> |

| | |
|---|---|
| 34 | </RAID> |

| | |
|---|---|
| 35 | <HDRIVE DriveId=“0” SizeMB=“8670” FreeMB=“” /> |
| 36 | <SysProfile></SysProfile> |

| | |
|---|---|
| 37 | </SYSTEM> |

| | |
|---|---|
| 38 | </SYSTEMSET> |

In addition to the vendor, model and MAC address, the SYSTEMS.XML file in the present example includes BIOS information at line 16, system motherboard information at line 14, chassis information at lines 13 and 15, processor information including the make, model CPUID, processor speed and version at lines 20 and 26 through 28, memory device information at line 35, memory summary information at lines 17 through 19, BUS inventory, storage inventory information such as RAID information at lines 21 through 23, the time and date of the hardware discovery at line 10, and the disk masterboot record inventory.

In addition to the SYSTEMS.XML file, the present invention also creates a log of the hardware inventory performed. An example hardware inventory log for a Compaq Proliant LD360G2 is given in Table 3.

TABLE 3

| BIOS | BIOS Vendor: Compaq | | | | | | | | |
|---|---|---|---|---|---|---|---|---|---|
| | BIOS Version: P26 | | | | | | | | |
| | BIOS Release: 06/25/2002 | | | | | | | | |
| | BIOS StartSeg: F000h | | | | | | | | |
| | BIOS ROMsize: 2048 KB | | | | | | | | |
| SYSTEM | Manufacturer: Compaq | | | | | | | | |
| MOTHERBOARD | Product Name: ProLiant DL360 G2 | | | | | | | | |
| | Version: | | | | | | | | |
| | Serial Number: | | | | | | | | |
| | UUID: [NASCNONHBOWDHFOLMCD] | | | | | | | | |
| | Wakeup Event: Power Switch | | | | | | | | |
| CHASSIS | Serial Number: | | | | | | | | |
| | Asset Tag: | | | | | | | | |
| | Lockable: NO | | | | | | | | |
| | Chassis Type: Rack Mount Chassis | | | | | | | | |
| | Bootup State: Unknown | | | | | | | | |
| | Power Supply: Unknown | | | | | | | | |
| | Thermal State: Unknown | | | | | | | | |
| | Security: Unknown | | | | | | | | |
| PROCESSOR | Processor Family: Pentium III | | | | | | | | |
| | Manufacturer: Intel | | | | | | | | |
| | Processor ID: 000006B4, 0383FBFFh (EAX, EDX) | | | | | | | | |
| | Processor Version: | | | | | | | | |
| | External Clock: 133 | | | | | | | | |
| | Max Speed(MHz): 1660 | | | | | | | | |
| | Currrent Speed: 1400 | | | | | | | | |
| | Core Voltage: 1.5 | | | | | | | | |
| CACHE DEVICE | Cache Level: L1 | | | | Cache Level: L2 | | | | |
| | Socketed: NO | | | | Socketed: NO | | | | |
| | Enabled: YES | | | | Enabled: YES | | | | |
| | Location: INTERNAL | | | | Location: INTERNAL | | | | |
| | Operating Mode: Write Back. | | | | Operating Mode: Varies with Memory Address. | | | | |
| | Cache Size: 32 KB Maximum | | | | Cache Size: 512 KB Maximum Installable: 2048 KB | | | | |
| | Installable: 32 KB | | | | Current SRAM Type: Burst Supported Types: Burst | | | | |
| | Current SRAM Type: Burst | | | | Cache Speed: 1 Nanosecs | | | | |
| | Supported Types: Burst | | | | ECC Type: Other | | | | |
| | Cache Speed: 1 Nanosecs | | | | Cache Type: None | | | | |
| | ECC Type: None | | | | Associativity: Unknown | | | | |
| | Cache Type: Other | | | | | | | | |
| | Associativity: 4-way Set-Associative | | | | | | | | |
| PORTS | Connector Type: Access Bus (USB) | | | | | | | | |
| | External Reference: USB Port 1 | | | | | | | | |
| | Connector Type: Access Bus (USB) | | | | | | | | |
| | Port Use: USB | | | | | | | | |
| SYSTEM SLOTS | Slot Designation: PCI Slot 1 | | | | Slot Designation: PCI Slot 2 | | | | |
| | Slot Type: PCI | | | | Slot Type: PCI | | | | |
| | Data Bus Width: 64 bit | | | | Data Bus Width: 64 bit | | | | |
| | Current Usage: In Use | | | | Current Usage: Available | | | | |
| | Slot Length: Long | | | | Slot Length: Long | | | | |
| | Slot ID: 0001 | | | | Slot ID: 0002 | | | | |
| | Slot Characteristics: | | | | Slot Characteristics: | | | | |
| | Provides 3.3 Volts | | | | Provides 3.3 Volts | | | | |
| SYSTEM MEMORY | Error Correction: Single-bit ECC | | | | | | | | |
| | Maximum Capacity: 4194304 KB | | | | | | | | |
| | Available Sockets: 4. | | | | | | | | |
| MEMORY DEVICES | Device Location: DIMM 1A | | | | | | | | |
| | Memory Type: SDRAM | | | | | | | | |
| | Error Info Handle: Info Not Available. | | | | | | | | |
| | Total Width in bits: 72 | | | | | | | | |
| | Data Width in bits: 64 | | | | | | | | |
| | Device Memory Size: 128 MB | | | | | | | | |
| | Device Set Number: 1 | | | | | | | | |
| | Memory Bank Location: | | | | | | | | |
| | Memory Type Details: Synchronous | | | | | | | | |
| | Memory Speed: 133 MHz | | | | | | | | |
| | Device Manufacturer: | | | | | | | | |
| | Device Part Number: | | | | | | | | |
| | Device Serial Number: | | | | | | | | |
| | Device Asset Tag: | | | | | | | | |
| MEMORY SUMMARY | Main Memory Size: 262144 KB 256 MB | | | | | | | | |
| BUS INVENTORY | PCI Bios present. Mech: 11 Version 2.16 PCI bus count: 11 | | | | | | | | |
| | Bus 0 (PCI) Device Number 5, Device Function 0 | | | | | | | | |
| | Vendor E11 Compaq | | | | | | | | |
| | Device B203 iLo Processor | | | | | | | | |
| | Class, SubClass, Interface: 088000 | | | | | | | | |
| | Command 0103 | | | | | | | | |
| | Status 0290 | | | | | | | | |
| | Revision 01 PCI Header Type: 80 | | | | | | | | |
| | Subsystem ID B206 HP Proliant iLo Advanced System Management Controller | | | | | | | | |
| | Subsystem Vendor ID 0E11 Compaq | | | | | | | | |
| | PCI Class Base Systems Peripheral, type Other | | | | | | | | |
| | Bus 0 (PCI) Device Number 5, Device Function 2 | | | | | | | | |
| | Vendor E11 Compaq | | | | | | | | |
| | Device B204 iLo Processor | | | | | | | | |
| | Class, SubClass, Interface: 088000 | | | | | | | | |
| | Command 0197 | | | | | | | | |
| | Status 0290 | | | | | | | | |
| | Revision 01 PCI Header Type: 80 | | | | | | | | |
| | Subsystem ID B206 HP Proliant iLo Management Interface Driver | | | | | | | | |
| | Subsystem Vendor ID 0E11 Compaq | | | | | | | | |
| | PCI Class Base Systems Peripheral, type Other | | | | | | | | |
| | Bus 0 (PCI) Device Number 15, Device Function 1 | | | | | | | | |
| | Vendor 1166 ServerWorks (Was: Reliance Computer Corp) | | | | | | | | |
| | Device 0212 CSB5 PCI EIDE Controller | | | | | | | | |
| | Class, SubClass, Interface: 01018A | | | | | | | | |
| | Command 0005 | | | | | | | | |
| | Status 0200 | | | | | | | | |
| | Revision 92 PCI Header Type: 80 | | | | | | | | |
| | Subsystem ID 0212 (not found) | | | | | | | | |
| | Subsystem Vendor ID 1166 ServerWorks (Was: Reliance Computer Corp) | | | | | | | | |
| | PCI Class Mass Storage Controller, type IDE | | | | | | | | |
| | Bus 0 (PCI) Device Number 15, Device Function 2 | | | | | | | | |
| | Vendor 1166 ServerWorks (Was: Reliance Computer Corp) | | | | | | | | |
| | Device 0220 OSB4 OHCI Compliant USB Controller | | | | | | | | |
| | Class, SubClass, Interface: 0C0310 | | | | | | | | |
| | Command 0157 | | | | | | | | |
| | Status 0280 | | | | | | | | |
| | Revision 05 PCI Header Type: 00 | | | | | | | | |
| | Subsystem ID 0220 OSB4 OHCI Compliant USB Controller | | | | | | | | |
| | Subsystem Vendor ID 1166 ServerWorks (Was: Reliance Computer Corp) | | | | | | | | |
| | PCI Class Serial Bus Controller, type USB (Universal Serial Bus), Open Host Controller | | | | | | | | |
| | Bus 1 (PCI) Device Number 4, Device Function 0 | | | | | | | | |
| | Vendor E11 Compaq | | | | | | | | |
| | Device B178 CISSB SMART2 Array Controller | | | | | | | | |
| | Class, SubClass, Interface: 010400 | | | | | | | | |
| | Command 0157 | | | | | | | | |
| | Status 02B0 | | | | | | | | |
| | Revision 01 PCI Header Type: 00 | | | | | | | | |
| | Subsystem ID 4080 Smart Array 5i Card | | | | | | | | |
| | Subsystem Vendor ID 0E11 Compaq | | | | | | | | |
| | PCI Class Mass Storage Controller, type RAID | | | | | | | | |
| | Bus 1 (PCI) Device Number 5, Device Function 0 | | | | | | | | |
| | Vendor 14E4 Broadcom Corp | | | | | | | | |
| | Device 1645 NetXtreme BCM5701 Gigabit Ethernet | | | | | | | | |
| | Class, SubClass, Interface: 020000 | | | | | | | | |
| | Command 0146 | | | | | | | | |
| | Status 02B0 | | | | | | | | |
| | Revision 15 PCI Header Type: 00 | | | | | | | | |
| | Subsystem ID 0085 NC7780 1000BaseTX (Embedded) | | | | | | | | |
| | Subsystem Vendor ID 0E11 Compaq | | | | | | | | |
| | PCI Class Network Controller, type Ethernet | | | | | | | | |
| | Bus 1 (PCI) Device Number 6, Device Function 0 | | | | | | | | |
| | Vendor 14E4 Broadcom Corp | | | | | | | | |
| | Device 1645 NetXtreme BCM5701 Gigabit Ethernet | | | | | | | | |
| | Class, SubClass, Interface: 020000 | | | | | | | | |
| | Command 0156 | | | | | | | | |
| | Status 02B0 | | | | | | | | |
| | Revision 15 PCI Header Type: 00 | | | | | | | | |
| | Subsystem ID 0085 NC7780 1000BaseTX (Embedded) | | | | | | | | |
| | Subsystem Vendor ID 0E11 Compaq | | | | | | | | |
| | PCI Class Network Controller, type Ethernet | | | | | | | | |
| | Bus 7 (PCI) Device Number 5, Device Function 0 | | | | | | | | |
| | Vendor 8086 Intel Corporation | | | | | | | | |
| | Device B152 S21152BB PCI to PCI Bridge | | | | | | | | |
| | Class, SubClass, Interface: 060400 | | | | | | | | |
| | Command 0147 | | | | | | | | |
| | Status 0290 | | | | | | | | |
| | Revision 00 PCI Header Type: 01 | | | | | | | | |
| | PCI Class Bridge Device, type PCI/PCI | | | | | | | | |
| | Bus 8 (PCI) Device Number 0, Device Function 0 | | | | | | | | |
| | Vendor 1002 ATI Technologies | | | | | | | | |
| | Device 4752 Rage XL PCI | | | | | | | | |
| | Class, SubClass, Interface: 030000 | | | | | | | | |
| | Command 0087 | | | | | | | | |
| | Status 0290 | | | | | | | | |
| | Revision 27 PCI Header Type: 00 | | | | | | | | |
| | Subsystem ID 001E (not found) | | | | | | | | |
| | Subsystem Vendor ID 0E11 Compaq | | | | | | | | |
| | PCI Class Display Controller, type PC Compatible, VGA | | | | | | | | |
| | Bus 8 (PCI)Lookup devices rc = 1 | | | | | | | | |
| | Device Number 1, Device Function 0 | | | | | | | | |
| | Vendor E11 Compaq | | | | | | | | |
| | Device A0F0 Advanced System Management Controller | | | | | | | | |
| | Class, SubClass, Interface: 088000 | | | | | | | | |
| | Command 0143 | | | | | | | | |
| | Status 0200 | | | | | | | | |
| | Revision 00 PCI Header Type: 00 | | | | | | | | |
| | Subsystem ID 00AE Advanced System Management Controller | | | | | | | | |
| | Subsystem Vendor ID 0E11 Compaq | | | | | | | | |
| | PCI Class Base Systems Peripheral, type Other | | | | | | | | |
| | Bus 8 (PCI) Device Number 2, Device Function 0 | | | | | | | | |
| | Vendor E11 Compaq | | | | | | | | |
| | Device 005A Vrc5074 [Nile 4] | | | | | | | | |
| | Class, SubClass, Interface: 058000 | | | | | | | | |
| | Command 0146 | | | | | | | | |
| | Status 2210 | | | | | | | | |
| | Revision 00 PCI Header Type: 00 | | | | | | | | |
| | Subsystem ID 00B2 (not found) | | | | | | | | |
| | Subsystem Vendor ID 0E11 Compaq | | | | | | | | |
| | PCI Class Memory Controller, type Other | | | | | | | | |
| | Bus 8 (PCI)Lookup devices rc = 100 | | | | | | | | |
| | Device Number 3, Device Function 0 | | | | | | | | |
| | Vendor E11 Compaq | | | | | | | | |
| | Device 00B1 (not found) | | | | | | | | |
| | Class, SubClass, Interface: 058000 | | | | | | | | |
| | Command 01C6 | | | | | | | | |
| | Status 0200 | | | | | | | | |
| | Revision 00 PCI Header Type: 00 | | | | | | | | |
| | Subsystem ID 00B3 (not found) | | | | | | | | |
| | Subsystem Vendor ID 0E11 Compaq | | | | | | | | |
| | PCI Class Memory Controller, type Other | | | | | | | | |
| STORAGE INVENTORY | Number of Fixed Drives: 1 | | | | | | | | |
| | Drive <0>: | | | | | | | | |
| | Disk EDD version: <3.0> BX: <AA55> CX Bitmap: <0001> | | | | | | | | |
| | Extensions: | | | | | | | | |
| | Fixed disk access subset | | | | | | | | |
| | Drive Parameters, drive 0 | | | | | | | | |
| | Info Flag Word: 2 | | | | | | | | |
| | Geometry in 4-15 is valid; | | | | | | | | |
| | Physical cylinders: 2176 | | | | | | | | |
| | Physical heads: 255 | | | | | | | | |
| | Physical sectors per track: 32 | | | | | | | | |
| | Physical sectors total: 17756160 <10ef000> | | | | | | | | |
| | Number of bytes per sector: 512 | | | | | | | | |
| | Drive Size is: 8,670 MB: 8,878,080.0 KB | | | | | | | | |
| | Device Path KEY is: <BEDD> | | | | | | | | |
| | Device Path Information is Present, length 36 bytes . . . | | | | | | | | |
| | Host Bus type: PCI Interface type: SCSI PCI Bus: 1 Slot: 4 Function: 0 | | | | | | | | |
| | SCSI Logical Unit: 0 | | | | | | | | |
| | Device Parameter Table Extension is NOT present. | | | | | | | | |
| DISK MASTER BOOT | Stat Type | Head | Cyl | Sec | Head | Cyl | Sec | Boot Sct | Num Sct |
| RECORD INVENTORY | 0x80 0x83 = Linux | 1 | 0 | 1 | 254 | 1,003 | 32 | 32 | 8,192,608 |
| | 0x00 0x82 = LinuxSW/Solaris | 0 | 1,004 | 1 | 254 | 1,023 | 32 | 8,192,640 | 2,048,160 |
| | 0x00 0x00 = Empty | | | | | | | | |
| | 0x00 0x00 = Empty | | | | | | | | |

Alternate embodiments of the present invention could populate the SYSTEMS.XML file with any of the information included in the example hardware inventory log shown above.

### EXAMPLE 3

Before a target computer is entered into the state machine by the provisioning program its discovery record is always read from the discovery file (DISCOV.XML) by the provisioning agent into a variable called BUILD-TYPE. The discovery file also stores information related to the type of installation this target computer will undergo. There are two types of installations. In no particular order, a first type of installation is referred to as cloning or image based. In image based provisioning the target computer receives a “snapshot” (an image of a hard drive) of a previously built similar device. To install the image on the target computer the provisioning agent of the present invention uses a vendor-imaging tool to lay down the bits of the image on the hard disk. This allows cloning of multiple devices utilizing the same image, and has the advantage of being, relatively, quick. According to the present invention, cloning or image based installations are accomplished by having the letter “C” in the Command tag of the discovery file. The second rule in the discovery file, as illustrated in the DISCOV.XML file below, specifies that the Compaq server identified by the MAC address 00-08-02-A9-3B-80 is to be provisioned using imaging, with a C being present between the command tags at line 13. When the provisioning agent looks at the discovery file and extracts the command, it interprets this provisioning methodology instruction that the target computer will be provisioned according to an image based installation.

DISCOV.XML

| | |
|---|---|
| 1 | <?xml version=“1.0” encoding=“UTF-8”?> |

| | |
|---|---|
| 2 | <!-- Verbatix 2.1 System Rules --> |
| 3 | <!-- This Document contains 3 Rules --> |
| 4 | <RULESET> |

| | |
|---|---|
| 5 | <RULE> |

| | |
|---|---|
| 6 | <Target Vendor=“Compaq” Model=“ProLiantDL360G2” MAC=“00-08-02- |

A2-5A-20” />

| | |
|---|---|
| 7 | <Locale>Y</Locale> |
| 8 | <Command>I</Command> |

| | |
|---|---|
| 9 | </RULE> |

| | |
|---|---|
| 10 | <RULE> |

| | |
|---|---|
| 11 | <Target Vendor=“Compaq” Model=“ProLiantDL360G1” MAC=“00-08-02- |

A9-3B-80” />

| | |
|---|---|
| 12 | <Locale>Y</Locale> |
| 13 | <Command>C</Command> |

| | |
|---|---|
| 14 | </RULE> |
| 15 | <RULE> |
| 16 | <Target Vendor=“SUNW” Model=“SUNW.UltraSPARC-IIi-cEngine” |

MAC=“08-00-20-DA-74-2C” />

| | |
|---|---|
| 17 | <Locale>Y</Locale> |
| 18 | <Command>I</Command> |

| | |
|---|---|
| 19 | </RULE> |

| | |
|---|---|
| 20 | </RULESET> |

The other type of installation is the unattended or silent installation. In an unattended installation a response file contains answers to all the questions that the Operating System installer (or any software installer program) expects the user to enter interactively. Referring to the example DISCOV.XML file above, when the provisioning agent running on the device identified by the MAC address 00-08-02-A2-5A-20 looks at the discovery file, it retrieves the value “I” (as illustrated between the command tags at line 8) and takes the branch of the code that will install the device using unattended installation.

In the presently preferred embodiment, the structure of all rules files is similar, whether they correspond to the states in cloning (imaging), unattended setups (silent installs), discovery or storing the state information. The CLONE1.XML rules file is shown in the example below:

CLONE1.XML

| | |
|---|---|
| 1 | <?xml version=“1.0” encoding=“UTF-8”?> |

| | |
|---|---|
| 2 | <!-- Verbatix 2.1 System Rules --> |
| 3 | <!-- This Document contains 2 Rules --> |
| 4 | <RULESET> |
| 5 | <RULE> |

| | |
|---|---|
| 6 | <Target Vendor=“000000” Model=“000000” MAC=“00-00-00-00-00-00” /> |
| 7 | <Locale>DoNotRemove</Locale> |
| 8 | <Command>InitRule</Command> |

| | |
|---|---|
| 9 | </RULE> |
| 10 | <RULE> |

| | |
|---|---|
| 11 | <Target Vendor=“Compaq” Model=“ProLiantDL360G2” MAC=“00-08-02- |

A9-3B-80” />

| | |
|---|---|
| 12 | <Locale>Z:\vendor\Compaq\RH8\scripts\DL360G2\</Locale> |
| 13 | <Command>clone1.bat</Command> |

| | |
|---|---|
| 14 | </RULE> |

| | |
|---|---|
| 15 | </RULESET> |

The provisioning agent running on the device identified by 00-08-02-A9-3B-80 uses the instruction set clone1.bat identified at line 13 of CLONE1.XML, at the location Z:\vendor\Compaq\RH8\scripts\DL360G2\ specified by the instruction set identifier at line 12.

The clone1.bat instruction set is shown below:

clone1.bat

1 @echo off
2 echo Executing Cloning rules
3 z:
4 cd clones
5 ghost-clone,mode=load,src=DL360G2.GHO,dst=1−sure
6 echo Done
7 z:\vendor\compaq\bin\reboot

The first instruction at line 1 turns echo off on the target, the second instruction at line 2 displays that this device will be executing cloning rules. The third instruction at line 3 directs the device to go to Z: drive, a location on the network. The fourth at line 4 instruction changes directory to clones on Z: drive. The fifth instruction of clone1.bat at line 5 launches “Ghost”, a vendor imaging tool distributed by Symantec™ with the parameters that instruct the utility (ghost) to load an image named DL360G2.GHO from the current location (z:\clones) on the first hard disk of the device and proceed without any user interaction (specified by—sure flag). This instruction uses ghost to lay down an image called DL360G2.GHO, previously captured using the ghost tool. While the present example specifies Ghost, the present invention is able to accommodate other imaging tools by specifying the name of the imaging program and the location of the imaging program in the instruction set.

Once the cloning process is completed by the ghost utility, the seventh instruction at line 7 reboots the target computer using the vendor supplied reboot utility stored in the bin directory in the vendor repository identified by the location z:\vendor\Compaq.

The provisioning agent makes this decision in step 1703. In case it finds that the BUILD-TYPE is “C”, it proceeds through steps 1704, 1705, 1706 and uses CLONE0.XML, CLONE1.XML, and CLONE2.XML respectively for provisioning this the target according to the image based provisioning process.

Alternatively, at step 1703, if the provisioning agent finds that the BUILD-TYPE is not “C”, it proceeds through steps 1707, 1708, 1709 and uses INSTALL0.XML, INSTALL1.XML, and INSTALL2.XML respectively for provisioning this device according to the unattended (or silent) provisioning process. In this manner the present invention defaults to the unattended (or silent) provisioning process in the event the BUILD-TYPE value does not indicate the image based provisioning process is to be used in provisioning the target computer.

While the presently preferred embodiment of the present invention defaults to the unattended (or silent) provisioning process, alternate embodiments of the present invention could have different default rules. For example, alternate embodiments could default to the image based provisioning process or could return an error if the BUILD-TYPE value does not indicate the unattended (or silent) provisioning process is to be used in provisioning the target computer.

### State Machine

FIG. 17 is a general flow diagram showing the progression of states 1700 in the present invention. The present invention provides for installation of an OS, or other software, through either an unattended installation process, or through an image-based process. At step 1701 the present invention is at state zero (State=0) where the system identifies the hardware of the target and updates the BIOS of the target. After step 1701 the system proceeds to step 1702 where the state proceeds to state one (State=1). In state one the system performs hardware and RAID configuration according to the rules set forth in the XML file associated with state one for the particular target. The system then proceeds to step 1703 where a determination is made as to whether the target is to be provisioned according to an Image Based process or an Unattended Installation process. As discussed above in Example 3, the presently preferred embodiment uses a provisioning methodology value in the discovery file to specify the provisioning process to be used. If at step 1703 the system determines that an Image Based process is to be used the system proceeds to step 1704 where state machine is advanced to state two (State=2). If at step 1703 the system determines that an Unattended Installation process is to be used the system proceeds to step 1707 where state machine is advanced to state five (State=5).

In state two the system performs a pre-cloning process according to the rules set forth in the XML file associated with state two for the particular target. From step 1704, the system proceeds to step 1705 and the state machine is advanced to state three (State=3). At state three the system performs a cloning (imaging) process according to the rules contained in the XML file associated with state three for the particular target. After the cloning process is complete, the system proceeds to step 1706 and the state machine is advanced to state four (State=4). At state four the system performs a post-cloning process according to the rules set forth in the XML file associated with state four for the particular target. After the post closing process is complete, the system proceeds to step 1710 and the state machine is advanced to state eight (State=8). Typically, at state eight and the system records that the target has been provisioned according to the process of the present invention, and the state/discovery database is updated as to the provisioned status of the target.

In state five the system performs a pre-installation process according to the rules set forth in the XML file associated with state two for the particular target. From step 1707 the system proceeds to step 1708 and the state machine is advanced to state six (State=6). In state six the system proceeds through the installation process. After the installation process is complete, the state machine advances to state seven (State=7) at step 1709. In state seven the system proceeds through a post-installation process. After the post-installation process is complete, the system proceeds to step 1710 and the state machine is advanced to state eight (State=8), as described in the preceding paragraph.

At any stage the state machine may enter the ninth state (State=100+any State), the snapshot state, before proceeding to the next state.

At any point the target may reboot, or the system crash, and the system will put the state machine into the same state when it resumes.

The state machine retrieves execution commands for the provisioning system by parsing the XML file to discern the rules.

The examples above demonstrates the power and flexibility of the present invention to use any third party tool (program) and vendor utilities to perform any configuration and installation tasks on the target computer using either a cloning (image) based approach or an unattended (silent ) install methodology.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

1. A method of installing software on a target computer, comprising:
applying a policy to said target computer;
selecting a build operator associated with said policy;
selecting a ruleset from the selected build operator, the selected ruleset including at least one provisioning rule;
selecting a provisioning rule from the selected ruleset, the selected provisioning rule including at least one provisioning instruction;
selecting a provisioning instruction from the selected provisioning rule; and
executing said provisioning instruction.

2. The method of claim 1, wherein the ruleset is selected according to a state value indicating the provisioning state of said target computer.

3. The method of claim 1, wherein provisioning rules include attribute criteria specifying conditions for using the provisioning rule, and wherein the provisioning rule is selected according to the attribute criteria of the provisioning rule.

4. The method of claim 3, wherein the attribute criteria includes a primary attribute criteria and at least one secondary attribute criteria.

5. The method of claim 4, wherein selection of the provisioning rule includes:
determining whether the attributes of said target computer match any of the primary attribute criteria of the rules of the ruleset;
selecting the provisioning rule having the primary attribute criteria matching the attribute of said target computer;
in the event none of the provisioning rules have primary attribute criteria matching the attribute of said target computer, determining whether the secondary attributes of said target computer match any of the primary attribute criteria of the rules of the ruleset; and
selecting the provisioning rule having the secondary attribute criteria matching the attribute of said target computer.

6. The method of claim 5, wherein the primary attribute criteria is a unique identifier of said target computer.

7. The method of claim 5, wherein the primary attribute criteria is a MAC address of said target computer.

8. The method of claim 5, wherein the secondary attribute criteria is a vendor identifier of said target computer.

9. The method of claim 5, wherein the secondary attribute criteria includes vendor and model identifiers of said target computer.

10. A method of installing software on a target computer by selecting a provisioning instruction to perform a task in provisioning said target computer, comprising:
retrieving attribute information on the attributes of said target computer;
retrieving policy information associated with a policy applied to said target computer;
selecting a build operator based on the retrieved policy information;
retrieving build operator information on the selected build operator;
retrieving a state value corresponding to said target computer;
selecting a ruleset according to the retrieved state file and the retrieved build operator information, the ruleset including at least one provisioning rule;
selecting from among the provisioning rules in the ruleset based on the retrieved target attribute information, wherein the selected provisioning rule including a provisioning instruction set;
extracting a provisioning instruction from the provisioning instruction set; and
executing the extracted provisioning instruction.

11. The method of claim 10, wherein the instruction set is identified by an instruction set name.

12. The method of claim 11; wherein the at least one provisioning instruction further includes a instruction set location identifier.

13. The method of claim 12, wherein the instruction set location identifier represents a network address where the instruction set can be retrieved.

14. The method of claim 12, wherein the instruction set location identifier represents a share on a provisioning server coupled to said target computer.

15. The method of claim 10, wherein the instruction set is an executable file.

16. The method of claim 12, wherein the instruction set is an executable file.

17. The method of claim 10, wherein the instruction set includes a plurality of provisioning instructions.

18. The method of claim 10, wherein the provisioning instruction specifies running a executable program.

19. The method of claim 18, wherein the executable program is a vendor tool.

20. A system for installing software on a target computer by selecting a provisioning instruction to perform a task in provisioning said target computer, comprising:
a state and discovery database for storing discovered attributes of a target computer and for storing information on the state of a process of provisioning software on said target;
a rules and policy database for storing policy information relating to software to be installed on said target computer and for storing provisioning rules and instructions; and
a provisioning engine for controlling the provisioning of software on said target computer, wherein the provisioning engine controls the installation of software on said target computer by:
retrieving attribute information on the attributes of said target computer;
retrieving policy information associated with a policy applied to said target computer;
selecting a build operator based on the retrieved policy information;
retrieving build operator information on the selected build operator;
retrieving a state value corresponding to said target computer;
selecting a ruleset according to the retrieved state file and the retrieved build operator information, the ruleset including at least one provisioning rule;
selecting from among the provisioning rules in the ruleset based on the retrieved target attribute information, wherein the selected provisioning rule including a provisioning instruction set;
extracting a provisioning instruction from the provisioning instruction set; and
executing the extracted provisioning instruction.
